(19) United States
(12) Patent Application Publication
(10) Pub. No.: US 2020/0272444 A1
(43) Pub. Date: Aug. 27, 2020

(54) PLACEMENT OF EXPLICIT PREEMPTION POINTS INTO COMPILED CODE

(71) Applicant: International Business Machines Corporation, ARMONK, NY (US)

(72) Inventor: KELVIN D. NILSEN, ROCHESTER, MN (US)

(21) Appl. No.: 16/282,807

(22) Filed: Feb. 22, 2019

(51) Int. Cl. G06F 8/41

(52) U.S. Cl. CPC G06F 8/4441

(57) ABSTRACT

Improvements in the placement of explicit preemption points into compiled code are disclosed. A control flow graph is created, from executable code, that includes every control path in a function. From the control flow graph, an estimated execution time for each control path is determined. For each control path, it is determined whether an estimated execution time of a control path exceeds a preemption latency parameter, wherein the preemption latency parameter is a maximum allowable time between preemption points. When it is determined that the estimated execution time of a particular control path violates the preemption latency parameter, an explicit preemption point is placed into the executable code that satisfies the preemption latency parameter.

### BACKGROUND

### Field of the Invention

The field of the invention is data processing, or, more specifically, methods, apparatus, and products for the placement of explicit preemption points into compiled code.

### Description of Related Art

The development of the EDVAC computer system of 1948 is often cited as the beginning of the computer era. Since that time, computer systems have evolved into extremely complicated devices. Today's computers are much more sophisticated than early systems such as the EDVAC. Computer systems typically include a combination of hardware and software components, application programs, operating systems, processors, buses, memory, input/output devices, and so on. As advances in semiconductor processing and computer architecture push the performance of the computer higher and higher, more sophisticated computer software has evolved to take advantage of the higher performance of the hardware, resulting in computer systems today that are much more powerful than just a few years ago.

In comparison with the use of legacy languages like C and C++, programs that use managed run-time environments providing support for tracing garbage collection of dead memory offer tremendous improvements in software developer productivity and large decreases in software maintenance costs. However, the use of so-called real-time garbage collection in time-critical applications typically extracts a high toll on system performance. Existing commercial time-critical virtual machine products usually run at less than half the speed of comparable virtual machine products that do not honor timeliness constraints.

One reason that time-constrained managed run-time environments run much slower is because the application code is required to continually coordinate with asynchronous garbage collection activities. Each pointer variable or field overwritten by an application thread must be communicated to the garbage collector as this impacts its assessment of which objects are garbage. Likewise, whenever the garbage collector relocates objects to reduce memory fragmentation, this must be communicated promptly to any application code that is accessing the objects.

Early designs of real-time garbage collection algorithms focused on shortening the typical time required to respond to asynchronous events, the so-called response time. Response time includes the time required to preempt the running thread (the preemption latency), switch contexts to the high-priority thread that is responsible for responding to the event, and allow the newly dispatched thread to complete the work that comprises the intended response. Other objectives, such as achieving high throughput of application code on multi-core platforms, assuring that recycling of memory by the garbage collector stays on pace with the application's consumption of memory, and obtaining tight bounds on the expected preemption latency rather than simply minimizing the average preemption latency, are of equal or even greater importance.

Analyses and proofs for compliance with timing constraints in real-time computing are often based on understanding various worst-case scenarios. Analysis of an application's timeliness is based on the application's thread execution times and on its preemption latencies. In terms of this analysis, there is little value in knowing that the typical thread preemption latency is 10 ns if the upper bound on preemption latency is no smaller than 200 μs. Such a system is unbalanced. As a managed run-time platform, it poorly serves the needs of time-critical developers. Insofar as time-critical developers need to assure compliance with timing constraints, they are much better served by a system that offers consistent preemption latency of, for example, no more than 1 μs rather than a system that offers unpredictable preemption latencies ranging from 10 ns to 200 μs. This is especially true if the system so configured offers improvements in overall performance, essentially cutting in half the expected execution times of each time-critical thread.

### SUMMARY

Embodiments according to the present disclosure establish a foundation for a balanced managed time-critical run-time environment supporting consistent preemption latencies of, for example, approximately 1 μs, with performance close to that of simpler managed run-time systems that do not support timeliness guarantees.

An embodiment of the invention is directed to a method for the placement of explicit preemption points into compiled code. The method comprises creating, from executable code, a control flow graph that includes every control path in a function, determining, from the control flow graph, an estimated execution time for each control path, determining, for each control path, whether an estimated execution time of a control path exceeds a preemption latency parameter, wherein the preemption latency parameter is a maximum allowable time between preemption points, determining that the estimated execution time of a particular control path violates the preemption latency parameter, and placing an explicit preemption point into the executable code that satisfies the preemption latency parameter.

Another embodiment of the present disclosure is directed to an apparatus for placement of explicit preemption points into compiled code, the apparatus comprising a computer processor, a computer memory operatively coupled to the computer processor, the computer memory having disposed within it computer program instructions that, when executed by the computer processor, cause the apparatus to carry out the steps of creating, from executable code, a control flow graph that includes every control path in a function, determining, from the control flow graph, an estimated execution time for each control path, determining, for each control path, whether an estimated execution time of a control path exceeds a preemption latency parameter, wherein the preemption latency parameter is a maximum allowable time between preemption points, determining that the estimated execution time of a particular control path violates the preemption latency parameter, and placing an explicit preemption point into the executable code that satisfies the preemption latency parameter.

Yet another embodiment of the present disclosure is directed to a computer program product for placement of explicit preemption points into compiled code, the computer program product disposed upon a computer readable medium, the computer program product comprising computer program instructions that, when executed, cause a computer to carry out the steps of creating, from executable code, a control flow graph that includes every control path in a function, determining, from the control flow graph, an estimated execution time for each control path, determining, for each control path, whether an estimated execution time of a control path exceeds a preemption latency parameter, wherein the preemption latency parameter is a maximum allowable time between preemption points, determining that the estimated execution time of a particular control path violates the preemption latency parameter, and placing an explicit preemption point into the executable code that satisfies the preemption latency parameter.

In various embodiments of the present disclosure, determining, from the control flow graph, an estimated execution time for each control path may include determining an estimated execution time for each basic block in the function.

In various embodiments of the present disclosure, placing an explicit preemption point into the executable code that satisfies the preemption latency parameter may include selecting an optimal point to place the preemption point based on an execution time budget for a prologue of the function.

In various embodiments of the present disclosure, placing an explicit preemption point into the executable code that satisfies the preemption latency parameter may include applying optimizing criteria that reduces the cost of performing context switches at each preemption point.

In various embodiments of the present disclosure, the optimizing criteria may include minimizing the number of live pointer variables.

In various embodiments of the present disclosure, the optimizing criteria may include minimizing the number of all live registers.

In various embodiments of the present disclosure, the estimated execution time is based on expected-case instruction timings for every instruction along every control path.

In various embodiments of the present disclosure, the estimated execution time is based on worst-case instruction timings for every instruction along every control path.

The foregoing and other objects, features and advantages of the invention will be apparent from the following more particular descriptions of exemplary embodiments of the invention as illustrated in the accompanying drawings wherein like reference numbers generally represent like parts of exemplary embodiments of the invention.

### BRIEF DESCRIPTION OF THE DRAWINGS

FIG. 1 is a network environment in accordance with embodiments of the present disclosure;

FIG. 2 is system diagram in accordance with embodiments of the present disclosure;

FIG. 3 is a program execution environment in accordance with embodiments of the present disclosure;

FIG. 4 is a flow chart illustrating a method in accordance with embodiments of the present disclosure;

FIG. 5 is a flow chart illustrating a method in accordance with embodiments of the present disclosure;

FIG. 6 is a flow chart illustrating a method in accordance with embodiments of the present disclosure;

FIG. 7 shows exemplary pseudocode for constructing a Reduction object following a T1 transformation according to embodiments of the present invention;

FIG. 8A shows exemplary pseudocode for constructing a Reduction object following a T2 transformation according to embodiments of the present invention;

FIG. 8B shows exemplary pseudocode, continued from FIG. 8A, for constructing a Reduction object following a T2 transformation according to embodiments of the present invention;

FIG. 9 shows exemplary pseudocode for implementing the insertPreemptionChecks function of the CodePath class according to embodiments of the present invention;

FIG. 10 shows exemplary pseudocode for implementing the accommodateTraversalPassOne function of the CodePath class according to embodiments of the present invention;

FIG. 11 shows exemplary pseudocode for implementing the accommodateTraversalPassTwo function of the CodePath class according to embodiments of the present invention;

FIG. 12 shows exemplary pseudocode for implementing the computeAttributes function of the CodePath class according to embodiments of the present invention;

FIG. 13 shows exemplary pseudocode for implementing the continueComputingAttributes function of the CodePath class according to embodiments of the present invention;

FIG. 14 shows exemplary pseudocode for implementing the adjustAttributes function of the CodePath class according to embodiments of the present invention;

FIG. 15 shows exemplary pseudocode for implementing the continueAdjustingAttributes function of the CodePath class according to embodiments of the present invention;

FIG. 16 shows exemplary pseudocode for an overriding implementation of the initializeAttributesForwardFlow function for the AlternationPath subclass according to embodiments of the present invention;

FIG. 17 shows exemplary pseudocode for an overriding implementation of the initializeAttributesForwardFlow function for the CatenationPath subclass according to embodiments of the present invention;

FIG. 18 exemplary pseudocode an overriding implementation of the initializeAttributesForwardFlow function for the IterationPath subclass according to embodiments of the present invention;

FIG. 19 shows exemplary pseudocode for an overriding implementation of the computeAttributesForwardFlow function for the AlternationPath subclass according to embodiments of the present invention;

FIG. 20A shows exemplary pseudocode for an overriding implementation of the computeAttributesForwardFlow function for the CatenationPath subclass according to embodiments of the present invention;

FIG. 20B shows exemplary pseudocode, continued from FIG. 20A for an overriding implementation of the computeAttributesForwardFlow function for the CatenationPath subclass according to embodiments of the present invention;

FIG. 21 shows exemplary pseudocode for an overriding implementation of the computeAttributesForwardFlow function for the IterationPath subclass according to embodiments of the present invention;

FIG. 22 shows exemplary pseudocode for implementing the markLoop function of the CodePath class according to embodiments of the present invention;

FIG. 23 shows exemplary pseudocode for implementing the calcPredMaxOblivionAtEnd function of the CodePath class according to embodiments of the present invention;

FIG. 24 shows exemplary pseudocode for implementing the insertLocalPreemptionCheckBackward function of the CodePath class according to embodiments of the present invention;

FIG. 25 shows exemplary pseudocode for implementing the insertOptimalPreemptionBackward function of the CodePath class according to embodiments of the present invention;

FIG. 26 shows exemplary pseudocode, continued from FIG. 25, for implementing the insertOptimalPreemptionBackward function of the CodePath class according to embodiments of the present invention;

FIG. 27 shows exemplary pseudocode for implementing the insertLocalPreemptionCheckForward function of the CodePath class according to embodiments of the present invention;

FIG. 28A shows exemplary pseudocode for implementing the insertOptimalPreemptionForward function of the CodePath class according to embodiments of the present invention;

FIG. 28B shows exemplary pseudocode, continued from FIG. 28A, for implementing the insertOptimalPreemptionForward function of the CodePath class according to embodiments of the present invention;

FIG. 29 shows exemplary pseudocode for implementing the bestBackwardRegisterPressure function of the CodePath class according to embodiments of the present invention;

FIG. 30 shows exemplary pseudocode for implementing the bestForwardRegisterPressure function of the CodePath class according to embodiments of the present invention;

FIG. 31 shows exemplary pseudocode for an overriding implementation of the calcPredMaxOblivionAtEnd method of the IterationPath according to embodiments of the present invention;

FIG. 32 is a diagram illustrating an optimal preemption point insertion in accordance with embodiments of the present disclosure; and

FIG. 33 is a diagram illustrating an optimal preemption point insertion in accordance with embodiments of the present disclosure.

### DETAILED DESCRIPTION

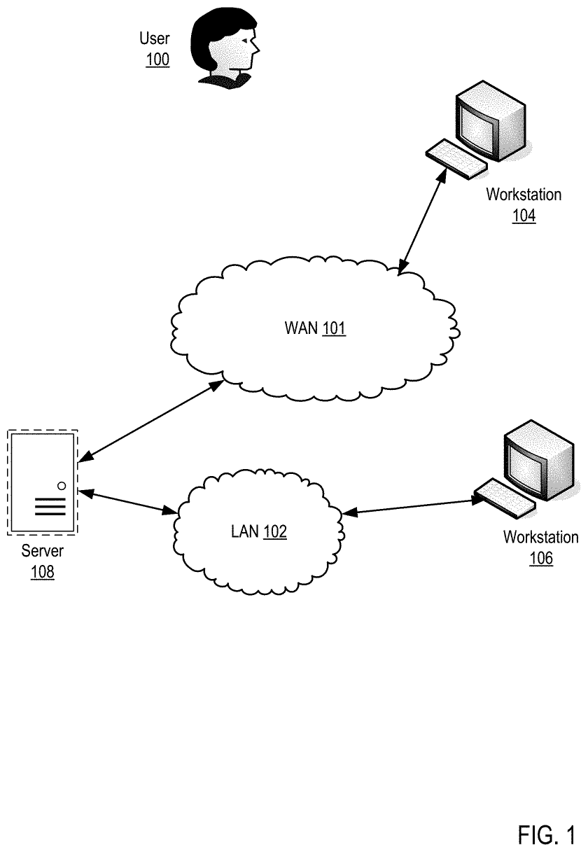

Exemplary methods, apparatus, and products for placement of explicit preemption points into compiled code in accordance with the present disclosure are described with reference to the accompanying drawings, beginning with FIG. 1. FIG. 1 sets forth a network diagram of a system configured for placement of explicit preemption points into compiled code according to embodiments of the present disclosure. The system of FIG. 1 includes a user (103) work station (104) that can communicate via a Wide Area Network (WAN) (101) to a server (108) configured for the placement of explicit preemption points into compiled code in accordance with the present disclosure. Alternatively, a user (103) work station (106) can communicate with the server (108) via a Local Area Network (LAN) (102).

The arrangement of servers and other devices making up the exemplary system illustrated in FIG. 1 are for explanation, not for limitation. Data processing systems useful according to various embodiments of the present disclosure may include additional servers, routers, other devices, and peer-to-peer architectures, not shown in FIG. 1, as will occur to those of skill in the art. Networks in such data processing systems may support many data communications protocols, including for example TCP (Transmission Control Protocol), IP (Internet Protocol), HTTP (HyperText Transfer Protocol), WAP (Wireless Access Protocol), HDTP (Handheld Device Transport Protocol), and others as will occur to those of skill in the art. Various embodiments of the present disclosure may be implemented on a variety of hardware platforms in addition to those illustrated in FIG. 1.

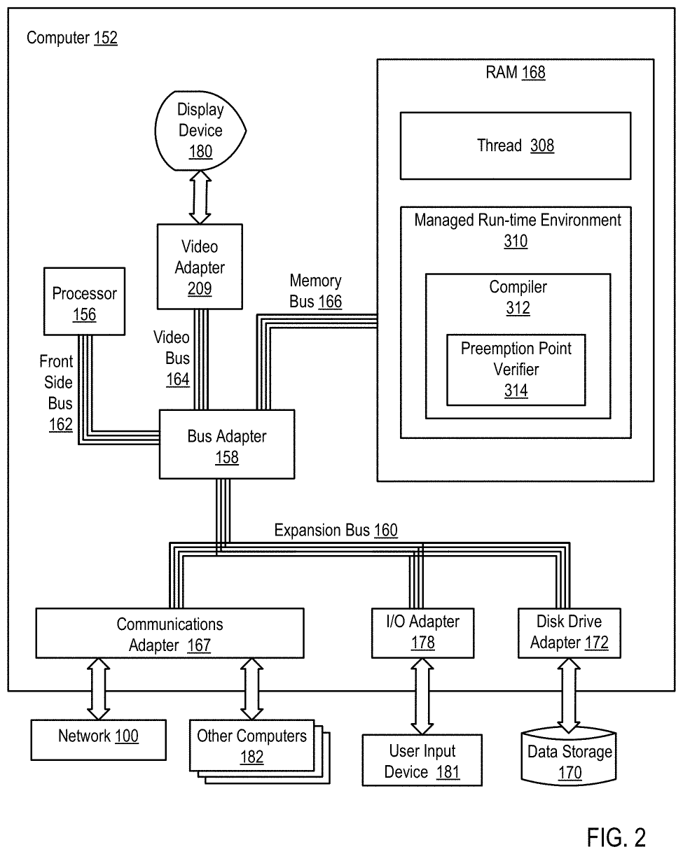

Placement of explicit preemption points into compiled code in accordance with the present disclosure is generally implemented with computers, that is, with automated computing machinery. In the system of FIG. 1, for example, all the server (108) and work stations (104, 106) are implemented to some extent at least as computers. For further explanation, therefore, FIG. 2 sets forth a block diagram of automated computing machinery comprising an exemplary computer (152) configured for placement of explicit preemption points into compiled code according to embodiments of the present disclosure. The computer (152) of FIG. 2 includes at least one computer processor (156) or ‘CPU’ as well as random access memory (168) (RAM′) which is connected through a high speed memory bus (166) and bus adapter (158) to processor (156) and to other components of the computer (152).

Stored in RAM (168) is a managed run-time environment (310), a module of computer program instructions for managing the execution of one or more threads (309). Also stored in RAM (168) are a compiler (312), a module of computer program instructions for translating program code of the one or more threads (309) into processor-executable instructions. Also stored in RAM (168), as part of compiler (312) is a preemption point verifier (314), a module of computer program instructions improved for placement of explicit preemption points into compiled code according to embodiments of the present disclosure.

The computer (152) of FIG. 2 includes disk drive adapter (172) coupled through expansion bus (160) and bus adapter (158) to processor (156) and other components of the computer (152). Disk drive adapter (172) connects non-volatile data storage to the computer (152) in the form of disk drive (170). Disk drive adapters useful in computers configured for placement of explicit preemption points into compiled code according to embodiments of the present disclosure include Integrated Drive Electronics (‘IDE’) adapters, Small Computer System Interface (SCSI′) adapters, and others as will occur to those of skill in the art. Non-volatile computer memory also may be implemented as an optical disk drive, electrically erasable programmable read-only memory (so-called ‘EEPROM’ or ‘Flash’ memory), RAM drives, and so on, as will occur to those of skill in the art.

The example computer (152) of FIG. 2 includes one or more input/output (′I/O′) adapters (178). I/O adapters implement user-oriented input/output through, for example, software drivers and computer hardware for controlling output to display devices such as computer display screens, as well as user input from user input devices (181) such as keyboards and mice. The example computer (152) of FIG. 2 includes a video adapter (209), which is an example of an I/O adapter specially designed for graphic output to a display device (180) such as a display screen or computer monitor. Video adapter (209) is connected to processor (156) through a high speed video bus (164), bus adapter (158), and the front side bus (162), which is also a high speed bus.

The exemplary computer (152) of FIG. 2 includes a communications adapter (167) for data communications with other computers (182) and for data communications with a data communications network (100). Such data communications may be carried out serially through RS-232 connections, through external buses such as a Universal Serial Bus (‘USB’), through data communications networks such as IP data communications networks, and in other ways as will occur to those of skill in the art. Communications adapters implement the hardware level of data communications through which one computer sends data communications to another computer, directly or through a data communications network. Examples of communications adapters useful in computers configured for placement of explicit preemption points into compiled code according to embodiments of the present disclosure include modems for wired dial-up communications, Ethernet (IEEE 802.3) adapters for wired data communications, and 802.11 adapters for wireless data communications.

Embodiments of the present disclosure are directed to improvements in a managed run-time environment, which may be implemented in the exemplary computer (152), to (a) bound the amount of execution time between preemption-safe points along all valid control paths, and (b) provide a compile-time algorithm that places explicit preemption points into generated code in order to establish balance between efficient execution of application threads and a tight upper bounded on preemption latency. The bound for preemption latency is tunable over a range of possible values. In examples according to embodiments of the present disclosure described herein, a typical execution time value for the preemption latency bound in time-critical systems may be 1 μs. Depending on the cycles per instruction (CPI) of the application workload and the processor clock rate, several thousand instructions may be executed between preemption-safe execution points within this preemption latency bound.

In embodiments of the present disclosure, CPU time (or process time) is the amount of time for which a central processing unit (CPU) such as processor (156) dedicates its resources to the execution of a particular thread of control. Since modern processors typically process more than one thread of control in parallel, partitioning of CPU time between multiple parallel threads is typically based on the dispatching of instructions. “Execution time” is used to describe the expected amount of CPU time required to execute the instructions that implement a particular capability. On modern computer architectures, the execution time required to execute a sequence of instructions may differ from the worst-case time by a factor of 100 or more due to differences in cache contents, contention with other threads for shared pipeline resources, the impacts of speculative execution, and other factors. It is common for soft-real-time developers to budget CPU time in terms of expected execution time rather than worst-case CPU time because this is more representative of the underlying computer's true workload capacity. The expected time to execute a sequence of instructions can be estimated, for example, by multiplying the number of instructions by a measurement of the target computer's average CPI on the workload of interest. Other estimation techniques, such as using a different CPI for each individual machine instruction to improve the accuracy of the estimate, measuring the typical CPU time of a particular instruction sequence when running in the context of the actual application, or other suitable techniques for measuring execution time to execute a sequence of instructions as known to those knowledgeable in the art may be employed without departing from the scope of the present disclosure.

The use of preemption-safe points in garbage collected systems is a technique for minimizing the overhead of coordinating between application and garbage collection threads. The compiler identifies certain points at which it is safe to preempt each application thread and context switches between threads are only allowed at these preemption-safe points. Postponing preemption until a thread reaches its next preemption-safe point has the effects of both increasing the thread's preemption latency and significantly improving the efficiency of the code that executes between explicit preemption points. During the long intervals between preemption points, with a typical interval executing a thousand or more instructions, the compiler has freedom to efficiently allocate registers, to introduce induction variable optimizations, and to perform other optimizations that might otherwise confuse a garbage collector's analysis of a thread's run-time stack and register usage. Furthermore, the cost of each context switch is also reduced. By allowing the compiler to select preemption points at which the number of live registers is small, the amount of state that needs to be saved and restored at each preemption point is much smaller than with context switches orchestrated by the operating system.

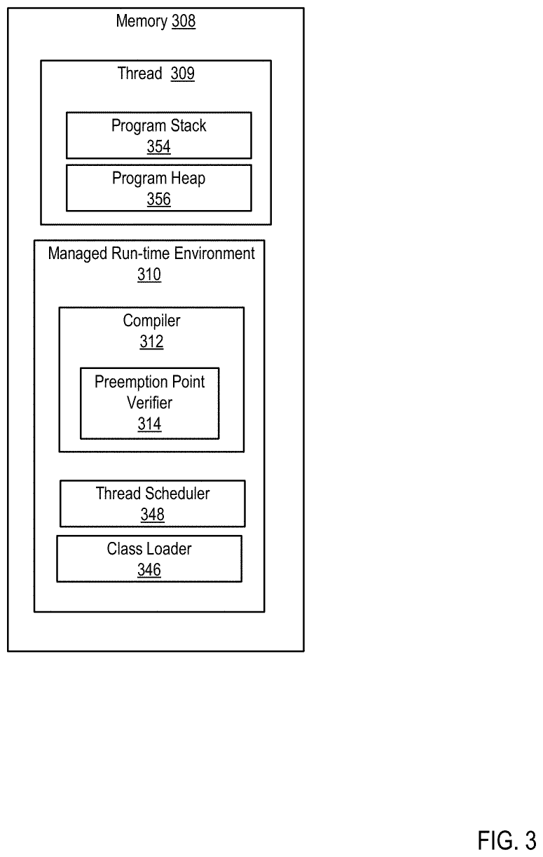

For further explanation, FIG. 3 shows a memory (308) of a typical multitasking computer system (152) which includes a random access memory (RAM) and non-volatile memory for storage. The memory (308) stores a managed run-time environment (310) and one or more threads (309). Each active thread (309) in the system is assigned a portion of the computer's memory, including space for storing the application thread program stack (354), a heap (356) that is used for dynamic memory allocation, and space for storing representations of execution states. The managed run-time environment (310) further includes a scheduling supervisor (348), which takes responsibility for deciding which of the multiple tasks being executed to dedicate CPU time to. Typically, the scheduling supervisor (348) must weigh tradeoffs between running application process threads and preempting threads when CPU resources need to be reassigned. Further, within the managed run-time environment (310), multiple independently developed applications may run concurrently.

In particular, the managed run-time environment (310) includes a compiler (312) that further includes a preemption point verifier (314) in accordance with the present disclosure, for verifying whether a compiled bytecode program satisfies certain preemption latency criteria. The managed run-time environment (310) also includes a class loader (346), which loads object classes into the heap.

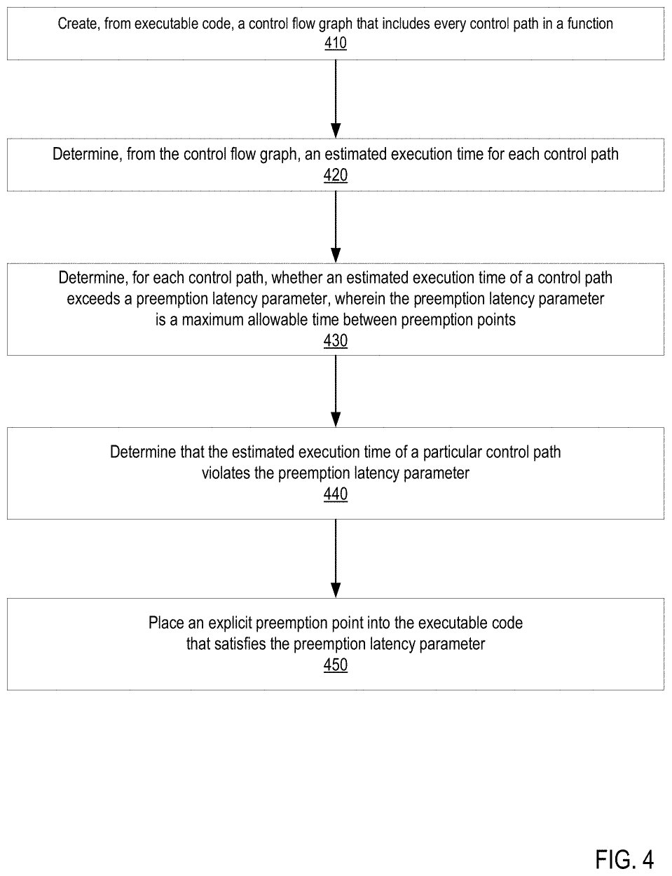

For further explanation, FIG. 4 sets forth a flow chart illustrating a further exemplary method for placement of explicit preemption points into compiled code according to embodiments of the present disclosure that includes creating, from executable code, a control flow graph that includes every control path in a function (410), determining, from the control flow graph, an estimated execution time for each control path (420), determining, for each control path, whether an estimated execution time of a control path exceeds a preemption latency parameter, wherein the preemption latency parameter is a maximum allowable time between preemption points (430), determining that the estimated execution time of a particular control path violates the preemption latency parameter (440), and placing an explicit preemption point into the executable code that satisfies the preemption latency parameter (450).

In the example method depicted in FIG. 4, a control flow graph is created from executable code that includes every control path in a function (410). A method is divided into basic blocks, with each basic block having a cost field to represent the expected CPU time required to execute the block and a boolean preemption check field to indicate whether this block includes a preemption check. Further, a control flow graph is represented by lists of successors and predecessors associated with each basic block. Distinct basic blocks represent the method's prologue and epilogue.

In determining, from the control flow graph, an estimated execution time for each control path (420), the estimated execution time is based on expected-case instruction timings for every instruction along every control path, particularly for soft real-time programming. In determining, from the control flow graph, an estimated execution time for each control path (420), the estimated execution time is based on worst-case instruction timings for every instruction along every control path, particularly for hard real-time programming.

In determining, for each control path, whether an estimated execution time of a control path exceeds a preemption latency parameter, wherein the preemption latency parameter is a maximum allowable time between preemption points (430), a method translation is assumed to maintain the following invariants: (1) the method checks and responds to a pending preemption request within a CPU time units of being invoked; (2) upon return from a method, control automatically flows through a preemption yielding trampoline subroutine if a pending preemption request was delivered more than gamma prior to the moment control returns to the caller; and (3) during its execution, the method implementation checks for preemption requests at least once every Psi CPU time units. The code that precedes a method invocation checks for preemption no more than Psi—alpha execution time units prior to the method invocation. The code that follows a method invocation checks for preemption no more than Psi—gamma execution time units following return from the method invocation. Though the invention can be configured to support a wide range of possible configuration options, a configuration according to embodiments of the present disclosure may implement the following values, represented in units of expected execution time: (a) Psi is 1 μs, and (b) While alpha and gamma are determined primarily as characteristics of the target architecture, typical values for both alpha and gamma are less than 50 ns. When a valid control path would exceed these values, it is determined that the estimated execution time of a particular control path violates the preemption latency parameter (440).

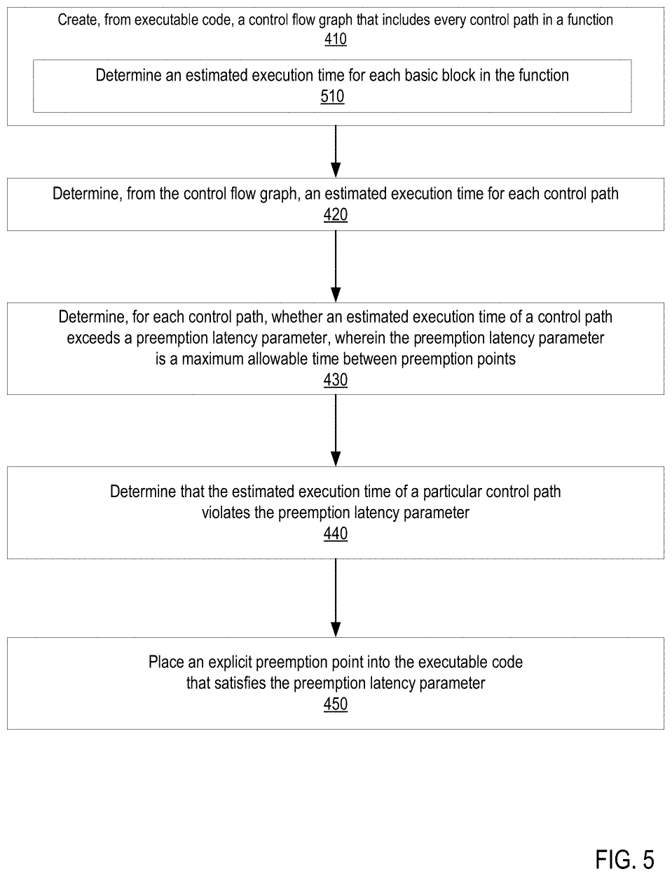

For further explanation, FIG. 5 sets forth a flow chart illustrating a further exemplary method for placement of explicit preemption points into compiled code according to embodiments of the present disclosure. The example method depicted in FIG. 5 is similar to the example method depicted in FIG. 4, as the example method depicted in FIG. 5 also includes creating, from executable code, a control flow graph that includes every control path in a function (410), determining, from the control flow graph, an estimated execution time for each control path (420), determining, for each control path, whether an estimated execution time of a control path exceeds a preemption latency parameter, wherein the preemption latency parameter is a maximum allowable time between preemption points (430), determining that the estimated execution time of a particular control path violates the preemption latency parameter (440), and placing an explicit preemption point into the executable code that satisfies the preemption latency parameter (450).

In the example method depicted in FIG. 5, determining, from the control flow graph, an estimated execution time for each control path (410) includes determining an estimated execution time for each basic block in the function (510).

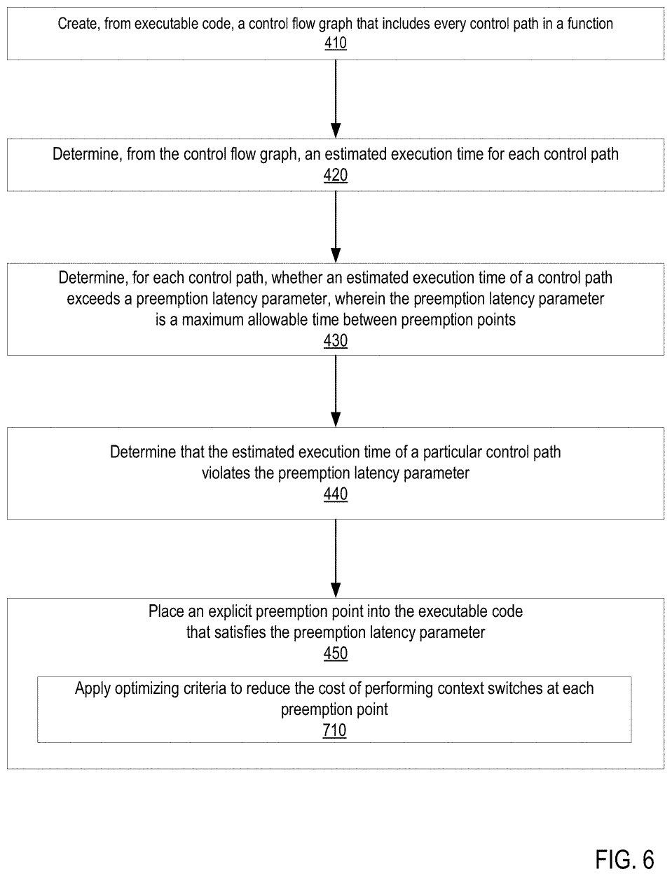

For further explanation, FIG. 6 sets forth a flow chart illustrating a further exemplary method for placement of explicit preemption points into compiled code according to embodiments of the present disclosure. The example method depicted in FIG. 6 is similar to the example method depicted in FIG. 4, as the example method depicted in FIG. 6 also includes creating, from executable code, a control flow graph that includes every control path in a function (410), determining, from the control flow graph, an estimated execution time for each control path (420), determining, for each control path, whether an estimated execution time of a control path exceeds a preemption latency parameter, wherein the preemption latency parameter is a maximum allowable time between preemption points (430), determining that the estimated execution time of a particular control path violates the preemption latency parameter (440), and placing an explicit preemption point into the executable code that satisfies the preemption latency parameter (450).

For further explanation, FIG. 6 sets forth a flow chart illustrating a further exemplary method for placement of explicit preemption points into compiled code according to embodiments of the present disclosure. The example method depicted in FIG. 6 is similar to the example method depicted in FIG. 4, as the example method depicted in FIG. 6 also includes creating, from executable code, a control flow graph that includes every control path in a function (410), determining, from the control flow graph, an estimated execution time for each control path (420), determining, for each control path, whether an estimated execution time of a control path exceeds a preemption latency parameter, wherein the preemption latency parameter is a maximum allowable time between preemption points (430), determining that the estimated execution time of a particular control path violates the preemption latency parameter (440), and placing an explicit preemption point into the executable code that satisfies the preemption latency parameter (450).

In the example method depicted in FIG. 6, placing an explicit preemption point into the executable code that satisfies the preemption latency parameter (450) includes reducing the cost of performing context switches at each preemption point by applying optimizing criteria (710). The placement of explicit preemption points may further be optimized by placing explicit preemption points at a function return to minimize the number of live registers. The placement of explicit preemption points may further be optimized by placing explicit preemption points to minimize the number of live pointer variables. Such optimizations are described in further detail with respect to the class and method implementation described below.

In an example embodiment according to the present disclosure, the translation of every method enforces the following invariants:
a. The method checks and responds to a pending preemption request within alpha execution time of being invoked. The target-specific constant alpha represents the maximum amount of time required to save all non-volatile registers that are to be overwritten by this method onto the thread's stack. A typical value of alpha is less than 50 ns. In the case that a leaf method needs only to preserve a small number of non-volatile registers, the implicit preemption check that occurs upon return from the method may occur within alpha execution time of entry into the method, thereby obviating a preemption check in the method's prologue.
b. Upon return from a method, control automatically flows through a preemption yielding trampoline subroutine if a pending preemption request was delivered more than gamma execution time prior to the moment control returns to the caller. The target-specific constant gamma represents the maximum amount of time required to restore non-volatile registers and return to the invoking method following preeemption performed by the trampoline function. A typical value of gamma is less than 50 ns.
c. During its execution, every method implementation checks for preemption requests at least once every Psi execution time units Psi is a configuration specific constant representing a preferred upper bound on preemption latency. A typical value of Psi is 1 microsecond. Related to enforcement of this constraint, the translation of a method invocation also enforces the following constraints:
   i. The code that precedes a method invocation checks for preemption no more than Psi—alpha execution time units prior to the method invocation.
   ii. The code that follows a method invocation checks for preemption no more than Psi—delta execution time units following return from the invoked method.

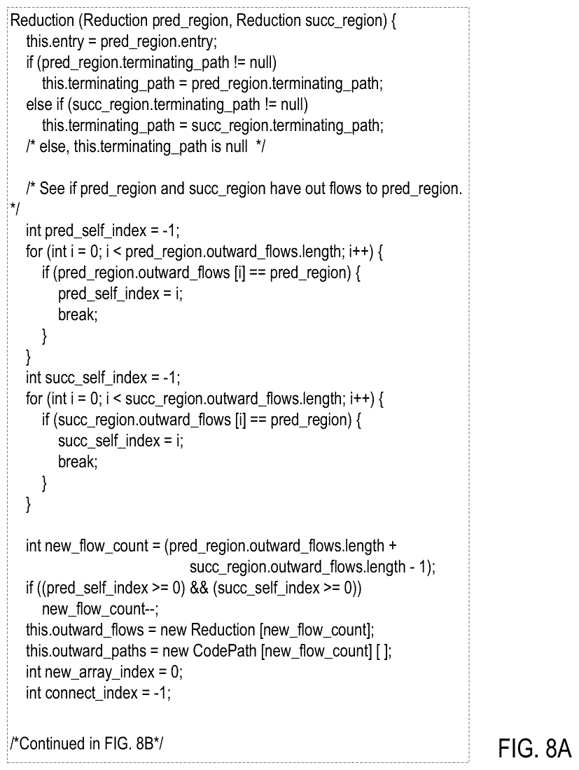

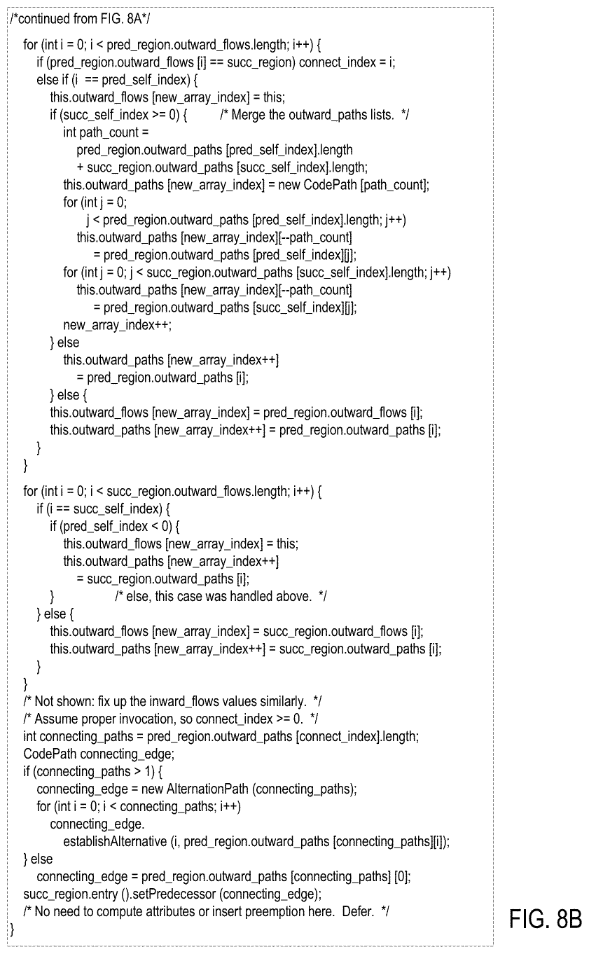

Libraries of data types, classes, methods, and other programming language constructs are defined to implement embodiments according to the present disclosure. By way of example and not limitation, the following description and references to the FIGS. 8-31 provide an example implementation these libraries.

In an example embodiment according to the present disclosure, for any basic block beta, certain defined attributes and services are described below. Many of the descriptions below speak of offsets within the basic block. An offset represents the distance from the first instruction in the basic block, measured in bytes. Explicit preemption checks are assumed, in this context, to occupy no instruction memory. The code that implements preemption checks is inserted during a subsequent compilation pass. This convention simplifies the implementation as it avoids the need to recompute all offsets each time a new preemption check is inserted into a basic block. For any basic block beta, defined attributes and services are described by the following according to embodiments of the present disclosure.

For any basic block beta, beta.checksPreemption ( ) is true if and only if basic block beta includes one or more implicit or explicit checks for preemption requests.

For any basic block beta, beta.invokesMethods ( ) is true if and only if basic block beta includes one or more method invocations.

For any basic block beta, beta.explicitlyChecksPreemption ( ) is true if and only if basic block beta includes one or more explicit checks for preemption requests.

For any basic block beta, beta.executionTime (offset) is the execution time of executing up to, but not including, the instruction at offset within the basic block. In the case that beta includes preemption checking code and offset is greater than beta.preemptionOffset (n), the execution time includes the costs of the first (n+1) preemption request checks, executing the code that for each case saves and restores registers and yields the CPU to a different thread. If beta does not include preemption checking code or offset is less than or equal to beta.preemptionOffset (0), the execution time does not include the cost of any preemption checks. beta.executionTime (−1) is defined to represent the execution time of the entire basic block, including any preemption check that is performed following the last instruction.

For any basic block beta, beta.oblivionAtStart ( ) represents the execution time of the instructions within beta that precede the first preemption check within beta if beta.checksPreemption ( ). Otherwise, beta.oblivionAtStart ( ) is the same as b.executionTime ( ).

For any basic block beta, beta.oblivionAtEnd ( ) represents the execution time of the instructions that follow the last check for preemption within beta if beta.checksPreemption ( ). Otherwise, beta.oblivionAtEnd ( ) is the same as beta.executionTime ( ).

For any basic block beta, beta.oblivionDuring ( ) is the maximum of beta.oblivionAtStart ( ), beta.oblivionAtEnd ( ), and the maximum execution time between any two consecutive (possibly implicit) checks within beta if beta.checksPreemption ( ). Otherwise, beta.oblivionDuring ( ) is the same as beta.executionTime ( ).

For any basic block beta, beta.preemptions ( ) represents the number of times preemption is implicitly or explicitly checked within basic block beta. Returns 0 if not beta.checksPreemption ( ).

For any basic block beta, beta.preemptionOffset (n) represents the offset within the basic block at which the n^{th} preemption check is performed. If the n^{th} preemption check is explicit, the check occupies no width in the instructions associated with block beta. Otherwise, this is the offset of the instruction that invokes a method that will perform preemption checks during its prologue or epilogue code. The first preemption check is represented by n=0.

For any basic block beta, beta.preemptionIsExplicit (n) is true if and only if the n^{th} preemption check is explicit. A false value means the n^{th} preemption check is implicit, as represented by a method invocation. The first preemption check is represented by n=0.

For any basic block beta, beta.oblivionThatFollows (n) is the maximum amount of oblivion, represented as execution time, that follows the n^{th} preemption check within block beta, not including oblivion that might occur in the successors of block beta. The first preemption check is represented by n=0. If n is the last preemption check within beta, this is the same as beta.oblivionAtEnd ( ). Otherwise, this is the maximum oblivion that may occur between the n^{th} preemption check and the (n+1)^{th} preemption check. In computing the maximum oblivion, this considers all possible scenarios, including the case that (a) the n^{th} preemption check may be either implicit or explicit, (b) the (n+1)^{th} preemption check may be either implicit or explicit, and (c) the n^{th} preemption check may have either yielded or not yielded to a pending preemption request.

For any basic block beta, beta.instructions ( ) represents the number of instructions contained within beta, excluding any instructions used to implement explicit preemption checks.

For any basic block beta, beta.instructionAt (offset) represents the number of the instruction found at offset within beta, excluding any instructions used to implement explicit preemption checks. The value of the offset argument is represented in bytes, with zero representing the first instruction in the basic block. This function is required because instructions are assumed to have variable width.

For any basic block beta, beta.instructionOffset (n) represents the offset within beta at which instruction n begins. If a preemption check immediately precedes instruction n, this returns the offset of the code that follows the preemption check. The first instruction is represented by n=0. If n equals beta.instructions ( ), this represents the offset following the last instruction contained within beta. In the case that beta ends with a conditional or unconditional branch, it is an error to insert preemption at the end of this block as the preemption check will not be seen along all flows exiting the block.

For any basic block beta, beta.registerPressureAt (offset) represents the number of equivalent general purpose registers holding live data at the specified offset within basic block beta. Each vector or other special purpose register that holds live data counts as the number of general purpose registers that are required to hold the equivalent amount of data. The value of the offset argument is represented in bytes, with zero representing the first instruction in the basic block.

For any basic block beta, beta.pointerRegisterPressureAt (offset) represents the number of registers holding live pointer data at the specified offset within basic block beta. Each vector or other special purpose register that holds live data counts as the number of general purpose registers that are required to hold the equivalent amount of data. The value of the offset argument is represented in bytes, with zero representing the first instruction in the basic block.

For any basic block beta, beta.insertPreemptionAt (offset) has the effect of causing an explicit preemption check to be performed immediately before the instruction at the specified offset within beta, or at the end of block beta if offset represents the instruction memory following the last instruction of beta. It is an error to invoke this service with an offset that does not represent the beginning or end of an instruction within beta. In the case that beta has multiple successors, a preemption check should not follow the last instruction in beta as a preemption check at this location will not be seen along all successor paths.

In an example embodiment according to the present disclosure, let omega=zeta.Paths (A, B) represent the set of all possible non-iterative paths from the start of basic block A to the end of basic block B within control flow graph zeta. The set zeta.Paths (A, A) comprises the single element representing a control flow through basic block A. Let rho represent a single non-iterative path in omega□ as represented by the sequence of basic blocks beta₀beta₁ . . . betaₙ₋₁. Let delta represent a subpath within rho. For the example embodiment, define the following properties:
A prefix subpath is understood to start with the first basic block of rho. A suffix subpath is understood to end with the last basic block of rho.
rho.checksPreemption ( ) is true if and only if at least one basic block on path rho checks for preemption. delta.checksPreemption ( ) is true if and only if subpath delta includes at least one basic block that checks for preemption requests. omega.checksPreemption ( ) is true if and only if rho.checksPreemption ( ) is true for every path rho in omega.
rho.executionTime ( ) is the sum of beta.executionTime ( ) for each basic block beta on path rho. delta.executionTime ( ) is the sum of beta.executionTime( ) for each basic block beta on subpath delta. omega.executionTime ( ) is the maximum rho.executionTime ( ) over all rho in omega.
rho.oblivionAtStart ( ) represents the maximum amount of execution time that a thread executing along a prefix path delta of rho ignores preemption requests. If not rho.checksPreemption ( ) this equals rho.executionTime ( ). Otherwise, this equals delta.executionTime ( ) plus lambda.oblivionAtStart ( ), where delta is the longest prefix of rho for which delta.checksPreemption ( ) is false, and lambda is the basic block that immediately follows delta in rho. omega.oblivionAtStart ( ) is the maximum of rho.oblivionAtStart ( ) over all rho in omega.
For a given prefix deltatheta of rho′, where deltatheta is represented by basic blocks beta₀beta₁ . . . betaₜₕₑₜₐ, deltaₜₕₑₜₐ.oblivionAtStartOngoing ( ) represents deltaₜₕₑₜₐ.executionTime ( ) if not deltaₜₕₑₜₐ.checksPreemption ( ). Otherwise, deltaₜₕₑₜₐ.oblivionAtStartOngoing( ) equals ET.zero. Conceptually, delta.oblivionAtStartOngoing ( ) represents the amount of oblivion that starts at the beginning of delta and is still ongoing at the end of delta. Note that multiple rho, in omega may pass through the same basic block betaₜₕₑₜₐ. For any rho′ in omega that passes through betaₜₕₑₜₐ, there is only one prefix deltaₜₕₑₜₐ that ends with block betaₜₕₑₜₐ since the set omega is assumed to contain only acyclic control flows. Let omegaₜₕₑₜₐ be the subset of omega that includes every path rho′ in omega that passes through basic block betaₜₕₑₜₐ. Define omegaₜₕₑₜₐ.oblivionAtStartOngoing ( ) to be the maximum value of deltaₜₕₑₜₐ.oblivionAtStartOngoing ( ) over all deltaₜₕₑₜₐ of rhoᵢ in omegaₜₕₑₜₐ.
rho.oblivionDuring ( ) represents the maximum execution time during which preemption requests might be ignored during execution along path rho. Assume rho is represented by the sequence of basic blocks beta₀beta₁ . . . betaₙ₋₁. For integer values i, j, and k greater than or equal to zero and less than n, define OblivionBetweenᵢₖ as follows: OblivionBetweenᵢᵢ is the maximum of betaᵢ.oblivionAtStart ( ), betaᵢ.oblivionDuring ( ), and betaᵢ.oblivionAtEnd ( ).
   OblivionBetweenₖⱼ if k=i+1, is betaᵢ.oblivionAtEnd ( )+betaⱼ.oblivionAtStart ( ).
   OblivionBetweenᵢₖ if k>i+1 and betaⱼ.checksPreemption ( ) is false for every j such that i<j and j<k, is betaᵢ.oblivionAtEnd ( )+betaₖ.oblivionAtStart ( )+the sum of betaⱼ.executionTime ( ) for all j such that i<j and j<k.
   OblivionBetweenᵢₖ is zero in all other cases.
rho.oblivionDuring ( ) is defined to equal the maximum of rho.oblivionAtStart ( ), rho.oblivionAtEnd ( ), and OblivionBetweenᵢₖ for all values of i and k with 0≤i≤k<n. omega.oblivionDuring ( ) is the maximum of rho.oblivionDuring ( ) for every rho in omega.
rho.oblivionAtEnd ( ) represents the maximum amount of execution time that a thread executing along a suffix of path rho ending at its last basic block ignores preemption requests. If not rho.checksPreemption ( ), this equals rho.executionTime ( ). Otherwise, this equals delta.executionTime ( ) plus lambda.oblivionAtEnd ( ), where delta is the longest suffix of rho for which delta.checksPreemption ( ) is false, and lambda is the block that immediately precedes delta in rho. omega.oblivionAtEnd ( ) is the maximum of rho.oblivionAtEnd ( ) over all rho in omega.

Class BasicBlock:

In an example embodiment according to the present disclosure, a BasicBlock object has methods to represent each of the properties and services described above with regard to the example basic block beta. Additionally, the BasicBlock class implements the following services:
int numPredecessors ( ): The number of predecessors of this BasicBlock.
int numSuccessors ( ): The number of successors of this BasicBlock.
BasicBlock predecessor (int n): Return the n^{th} predecessor of this BasicBlock.
BasicBlock successor (int n): Return the n^{th} successor of this BasicBlock.

Class ET:

In an example embodiment according to the present disclosure, a class ET is a final concrete class providing an abstraction that represents constant (immutable) execution time values. This quantity is represented as an abstract data type in order to facilitate maintenance and evolution of the implementation in response to anticipated evolution of execution time measurement and enforcement capabilities. The following static fields are supported:
static final ET Undefined: This final field references an ET object representing an undefined amount of execution time. The result of boolean tests on an undefined value is always false. The result of arithmetic operations on an undefined value is an undefined value.
static final ET Zero: This final field references an ET object representing zero execution time.
static final ET Infinity: this final field references an ET object that represents an infinite amount of execution time. Infinity is greater than any finite value. Magnitude comparisons between Infinity and Infinity return false. Infinity plus or minus any finite value equals Infinity. Infinity plus Infinity equals Infinity. The result of subtracting Infinity from Infinity and of adding Infinity and NegativeInfinity is Undefined.
static final ET NegativeInfinity: this final field references an ET object that represents an infinite amount of execution time. NegativeInfinity is less than any finite value. Magnitude comparisons between NegativeInfinity and NegativeInfinity return false. NegativeInfinity plus or minus any finite value equals NegativeInfinity. NegativeInfinity plus NegativeInfinity equals NegativeInfinity. The result of subtracting NegativeInfinity from NegativeInfinity and of adding Infinity and NegativeInfinity is Undefined.

In an example embodiment according to the present disclosure, services implemented by the ET class are described:

ET (long nanoseconds): Instantiate an ET object which represents the amount of CPU time consumed by running this thread continuously for the specified number of nanoseconds.

final boolean gt (ET other): Returns true if and only if this ET object has magnitude greater than the magnitude of “other” ET object. Returns false if not this.isDefined ( ) or not other.isDefined ( ), or if this ET object has a magnitude less than or equal to the magnitude of other.

final boolean ge (ET other): Returns true if and only if this ET object has magnitude greater than or equal to the magnitude of “other” ET object. Returns false if not this.isDefined 0 or not other.isDefined ( ), or if this ET object has a magnitude less than the magnitude of other.

final boolean lt (ET other): Returns true if and only if this ET object has magnitude less than the magnitude of “other” ET object. Returns false if not this.isDefined ( ) or not other.isDefined ( ), or if this ET object has a magnitude greater than or equal to the magnitude of other.

final boolean le (ET other): Returns true if and only if this ET object has magnitude less than or equal to the magnitude of “other” ET object. Returns false if not this.isDefined ( ) or not other.isDefined ( ), or if this ET object has a magnitude greater than the magnitude of other.

final boolean eq (ET other): Returns true if and only if this ET object has magnitude equal to the magnitude of “other” ET object. Returns false if not this.isDefined ( ) or not other.isDefined ( ), or if this ET object has a magnitude not equal to the magnitude of other.

final ET sum (ET other): Returns a new ET object to represent the sum of this and other. Returns ET.Undefined if not this.isDefined ( ) or not other.isDefined ( ) or if not this.isFinite ( ) and not other.isFinite( ) and other not equal to this.

final ET difference (ET other): Returns a new ET object to represent the difference of this and other. Returns ET.Undefined if not this.isDefined ( ) or not other.isDefined ( ) or if not this.isFinite ( ) and not other.isFinite ( ) and other equals this.

final ET product (int multiplier): Returns a new ET object to represent the product of this and multiplier. Returns ET.Undefined if not this.isDefined ( ).

final boolean isDefined ( ): Returns true if and only if this ET object has a defined value (i.e., not equal to ET.Undefined).

final boolean isFinite ( ): Returns true if and only if this ET object has a finite value (ie. not equal to ET.Undefined, ET.Infinity, or ET.NegativeInfinity).

Class ETC:

In an example embodiment according to the present disclosure, the class ETC is a concrete class that is an execution time container. The services implemented by the ETC class include:
ETC (ET value): Instantiates an ET object which represents the same amount of ET as its value argument.
ET set (ET value): Overwrites the value held in this container, returning the previous value of the container ( ).
ET get ( ): Returns the current value held in this container.

Class CodePath:

In an example embodiment according to the present disclosure, the class CodePath is an abstract class representing a set of non-iterative flows through an associated control-flow graph. Concrete subclasses of CodePath include CatenationPath, AlternationPath, and IterationPath. Each CatenationPath object is associated with a single basic block.

A CodePath data structure is a representation of a control flow graph. It consists of multiple CodePath instances linked together by predecessor relationships. A traversal of the CodePath data structure is a subgraph of the complete data structure, representing all non-iterative paths from a particular entry point to a particular end point. The traversal is identified by a start_sentinel value and a specified end node. The start_sentinel value is the predecessor of the entry node for the traversal. By convention, each traversal has a single entry point and a single exit point. Traversals of this form are sufficient to cover any reducible control flow graph. Within a particular traversal, each CodePath instance represents the set of all non-iterative control flows from the entry node of the traversal to the specified end node.

Inasmuch as each CodePath instance represents a set of control flows, each CodePath object implements all of the services described above with regard to basic block beta and pertaining to the associated set of control flows. For IterationPath instances, these services have special significance:
executionTime ( ) denotes the time to execute the control path that starts at the traversal's entry point and flows to the IterationPath instance without iterating through the loop body.
checksPreemption ( ) denotes whether the control path from the traversal's entry point to the IterationPath instance without iteration through the loop body has a preemption check.
oblivionAtStart ( ) denotes the oblivion at the start of the control path from the traversal's entry point to the IterationPath instance without iteration through the loop body.
oblivionAtEnd ( ), unlike the attributes described above, accounts for the behavior of the loop body. The service oblivionAtEnd ( ) is the maximum of the oblivion at the end of the control path from the traversal's entry point to the IterationPath instance without iteration through the loop body and oblivion at the end of the loop body. Every loop body checks for preemption at least once.
oblivionDuring ( ) is computed in the traditional way for the control path from the traversal's entry point to the IterationPath instance without iteration through the loop body. However, if the IterationPath instance's oblivionAtEnd ( ) attribute is greater than the oblivionDuring ( ) attribute computed in this way, then oblivionDuring ( ) is the same as oblivionAtEnd ( ). This corresponds to the case that the loop body has a large value of oblivionAtEnd ( ).

In addition to other instance fields to represent services described above, each CodePath object also maintains the following instance fields:

private int expected_visits: This private integer field represents the number of expected backwards-directed visits by successors of this node in the most current traversal.

private int visits: This private integer field represents the number of backwards-directed visits by successors of this node that have been realized in the most current traversal.

private int forward_visits: This private integer field represents the number of forward-directed visits by predecessors of this node that have been realized in the most current traversal. The expected number of forward_visits is the same as the number of predecessors.

private ET max_oblivion_at_end: This private field represents the most restrictive of the max_oblivion_at_end constraints imposed on this CodePath instance by backwards traversals through this CodePath instance

private ET max_tolerance_at_end: This private field represents the tolerance associated with the most restrictive of the max_oblivion_at_end constraints imposed by backwards traversals through this CodePath instance.

private CodePath [ ] traversal_successors: This private array field represents the successor CodePath objects in the most current traversal.

In an example embodiment according to the present disclosure, the CodePath class implements the following non-private services:

Traversal ( ): Returns a reference to the Traversal object that is currently involved in analyzing this CodePath object. This association is overwritten each time a Traversal object affecting this CodePath object is instantiated.

BasicBlock associatedBlock ( ): Obtains a reference to the BasicBlock object that is directly associated with this CodePath instance. In the case that this is an AlternationPath or IterationPath, there is no directly associated BasicBlock so this method returns null.

final int predecessorCount ( ): Returns how many predecessors this CodePath object has. CatenationPath and IterationPath instances have only a single predecessor. An AlternationPath object may have an arbitrarily large number of predecessors.

final CodePath predecessor (int n): Obtains a reference to the n^{th} predecessor of this CodePath object, where the first predecessor is represented by n=0.

final int loopNestingLevel ( ): Returns the number of levels of nested loops that enclose this CodePath object. A value of zero denotes that this CodePath object is not contained within any loop. A newly instantiated CodePath object has nesting level 0.

final void incrementLoopNestingLevel ( ): Adds 1 to the count of nesting levels associated with this CodePath object.

final ET localExecutionTime ( ): The amount of execution time to execute the directly associated basic block if there is one, including the time required to execute any explicit preemption checks that have been inserted into this basic block. If there is no directly associated basic block, the value is ET.Zero.

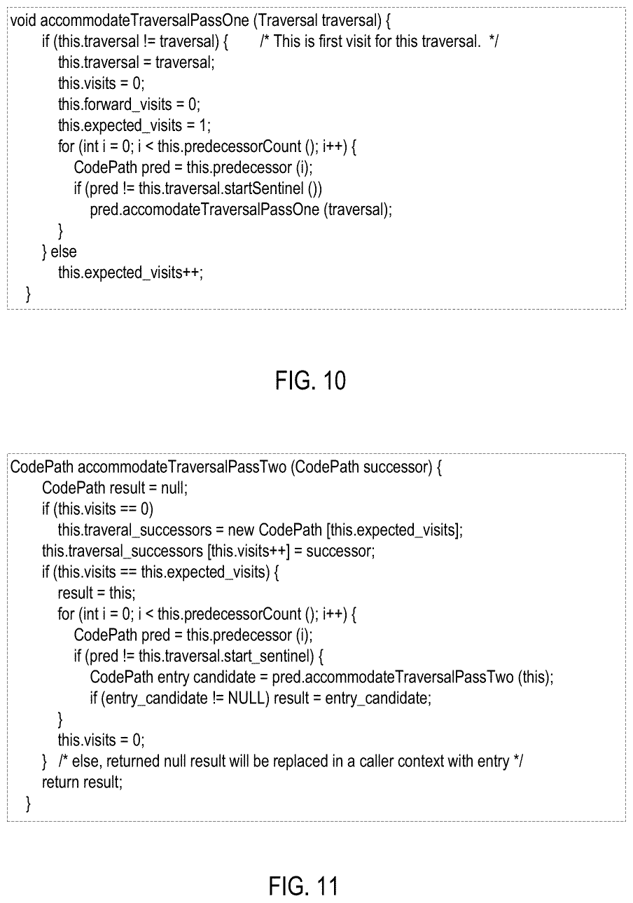

void accommodateTraversalPassOne (Traversal traversal): FIG. 10 shows exemplary pseudocode for implementing the accommodateTraversalPassOne function according to embodiments of the present invention. This method is invoked as part of setting up a new traversal through this CodePath object.

CodePath accommodateTraversalPassTwo (CodePath successor): FIG. 11 shows exemplary pseudocode for implementing the accommodateTraversalPassTwo function according to embodiments of the present invention. This method is invoked as part of setting up a new traversal through this CodePath object.

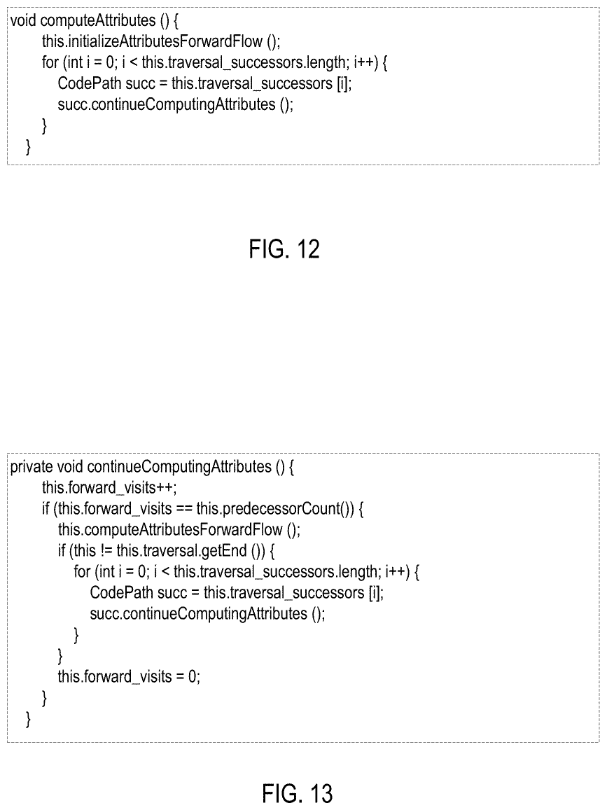

void computeAttributes ( ): FIG. 12 shows exemplary pseudocode for implementing the computeAttributes function according to embodiments of the present invention. This method starts a depth-first traversal from the traversal entry and descending toward the traversal end. As individual CodePath nodes are visited, their associated attributes are computed. A Traversal object's computeAttributes method invokes entry.computeAttributes Oto begin the process of computing the attributes for the CodePath data structure representing a particular Traversal.

private void continueComputingAttributes ( ): FIG. 13 shows exemplary pseudocode for implementing the continueComputingAttributes function according to embodiments of the present invention. This method continues the depth-first traversal that is initiated by the computeAttributes ( ) method.

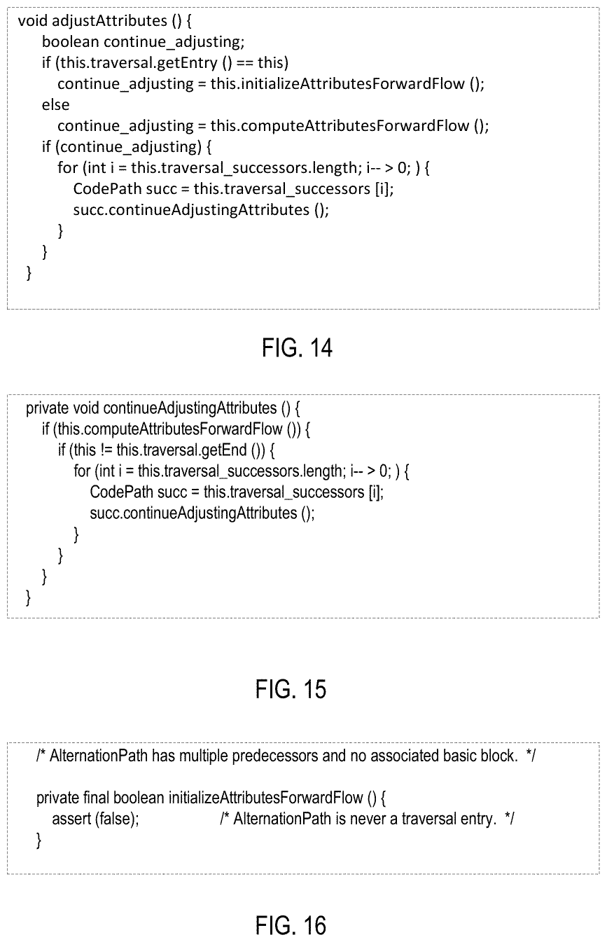

void adjustAttributes ( ): FIG. 14 shows exemplary pseudocode for implementing the adjustAttributes function according to embodiments of the present invention. Having previously computed all of the attributes for a particular traversal, this method recomputes the attributes that might be affected by insertion of a new preemption check into this CodePath node.

private void continueAdjustingAttributes ( ): FIG. 15 shows exemplary pseudocode for implementing the continueAdjustingAttributes function according to embodiments of the present invention. Having previously computed all of the attributes for a particular traversal, this method continues recomputation of the attributes that might be affected by insertion of a new preemption check into one of its ancestor nodes.

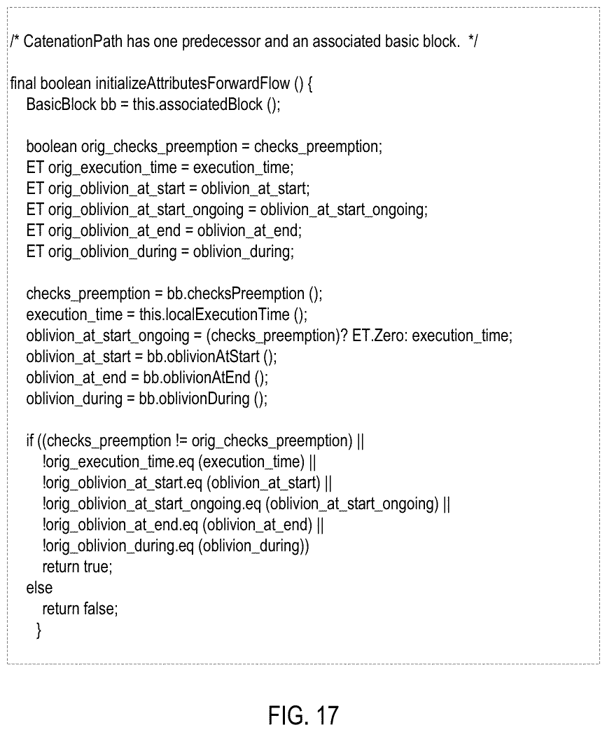

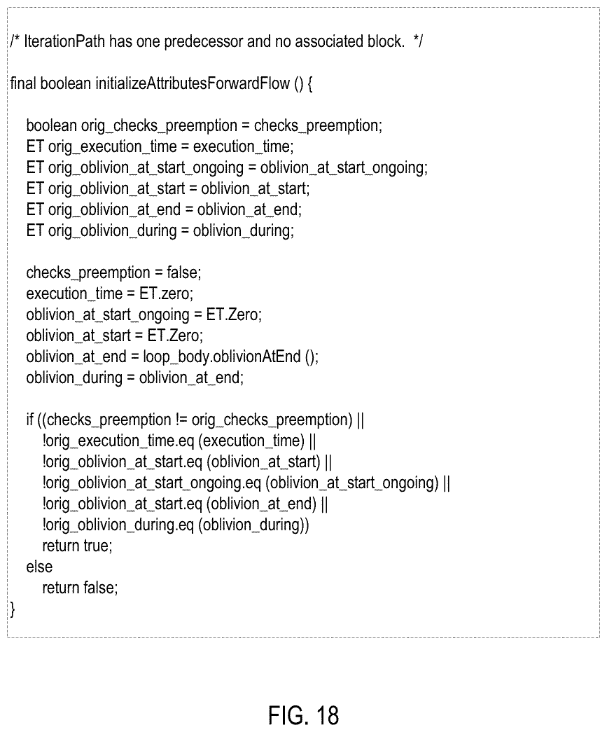

abstract boolean initializeAttributesForwardFlow ( ): Given that this CodePath instance equals this.traversal.getEntry ( ) and there are therefore no traversal predecessors of this CodePath node, compute the forward flowing attributes for this node. Forward flowing attributes include checksPreemption ( ), executionTime ( ), oblivionAtStart ( ), oblivionAtStartOngoing, oblivionDuring ( ), and oblivionAtEnd ( ). Returns true if and only if this invocation has caused this node's attributes to change. As this is an abstract method, each of the AlternationPath, CatenationPath, and IterationPath subclasses provide overriding implementations. FIG. 16 shows exemplary pseudocode for an overriding implementation of the initializeAttributesForwardFlow function for the AlternationPath subclass according to embodiments of the present invention. FIG. 17 shows exemplary pseudocode for an overriding implementation of the initializeAttributesForwardFlow function for the CatenationPath subclass according to embodiments of the present invention. FIG. 18 shows exemplary pseudocode for an overriding implementation of initializeAttributesForwardFlow function for the IterationPath subclass according to embodiments of the present invention.

abstract boolean computeAttributesForwardFlow ( ): Given that the forward flowing information has already been computed for all traversal predecessors of this CodePath node, compute the forward flowing attributes for this node. Returns true if and only if this invocation has caused this node's attributes to change. An exemplary pseudocode for implementation of the computeAttributesForwardFlow function of the CodePath class according to embodiments of the present invention is: abstract boolean computeAttributesForwardFlow ( ). As this is an abstract method, each of AlternationPath, CatenationPath, and IterationPath subclasses provide overriding implementations, described below.

boolean isIterationPath ( ): This method returns true if and only if this object is an instance of IterationPath.

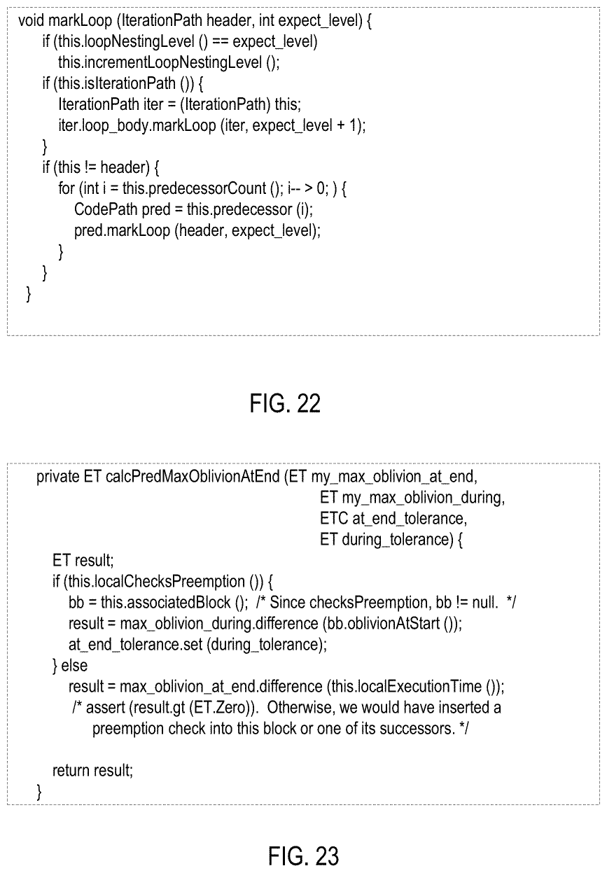

void markLoop (IterationPath header, int expect_level): This method implements a depth-first backwards-flowing traversal starting from the loop body of its header argument. Recursion stops upon encountering the header node. This method increments the loop count for nodes whose current loop count equals the value of its expect_level argument. Nodes with a different expect level are either contained within an inner-nested loop or have been visited redundantly by this loop body traversal. FIG. 22 shows exemplary pseudocode for implementing the markLoop function according to embodiments of the present invention.

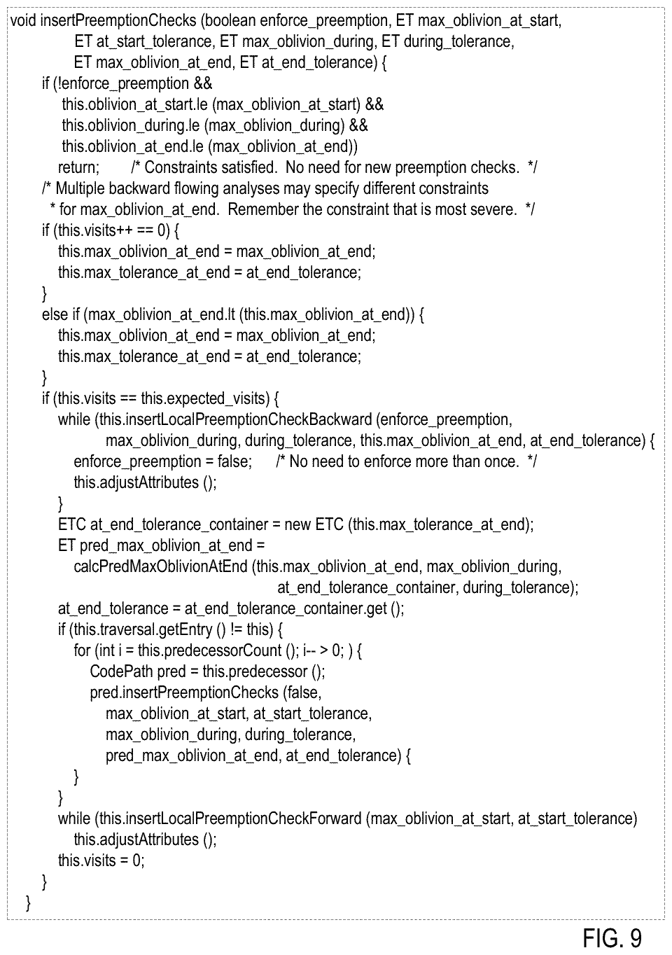

void insertPreemptionChecks (boolean enforce_preemption, ET max_oblivion_at_start, ET at_start_tolerance, ET max_oblivion_during, ET during_tolerance, ET max_oblivion_at_end, ET at_end_tolerance): This method implements a depth-first traversal for the purpose of inserting preemption checks to enforce the constraints described by the method's arguments: (a) if enforce_preemption is true, this assures that every path from traversal.getEntry ( ) to the end of this node has a preemption check; (b) assures that this.oblivion_at_start is less than or equal to max_oblivion_at_start along every path from traversal.getEntry ( ) to the end of this node; (c) if it is necessary to inserts a preemption check to enforce the max_oblivion_at_start constraint along any control flow from traversal.getEntry ( ) to this node, insert the preemption check following max_oblivion_at_start.difference (at_start_tolerance) of execution time along that control flow; (d) assures that this.oblivion_during is less than or equal to max_oblivion_during along every path from traversal.getEntry ( ) to the end of this node; (e) if it is necessary to insert a preemption check to enforce the max_oblivion_during constraint along any control flow from traversal.getEntry ( ) to this node, inserts the preemption check no less than max_oblivion_during.difference (during_tolerance) of execution time before any following preemption check along that control flow; (f) assures that this.oblivion_at_end is less than or equal to max_oblivion_at_end along every path from traversal.getEntry ( ) to the end of this node; and (g) if it is necessary to insert a preemption check to enforce the max_oblivion_at_end constraint along any control flow from traversal.getEntry ( ) to this node, inserts the preemption check no less than max_oblivion_at_end.difference (at_end_tolerance) of execution time from the end of this CodePath instance. Whenever a preemption check is inserted, all affected attributes are recomputed. FIG. 9 shows exemplary pseudocode for implementing the insertPreemptionChecks function according to embodiments of the present invention.

private ET calcPredMaxOblivionAtEnd (ET my_max_oblivion_at_end, ET my_max_oblivion_during, ETC at_end_tolerance container, ET during_tolerance): This method calculates and returns the value of the max_oblivion_at_end argument to be passed to recursive invocations of insertPreemptionChecks for the predecessors of this CodePath node. If necessary, overwrites the value of the at_end_tolerance argument which will also be passed to the recursive invocations of insertPreemptionChecks. FIG. 23 shows exemplary pseudocode for implementing the calcPredMaxOblivionAtEnd function according to embodiments of the present invention.

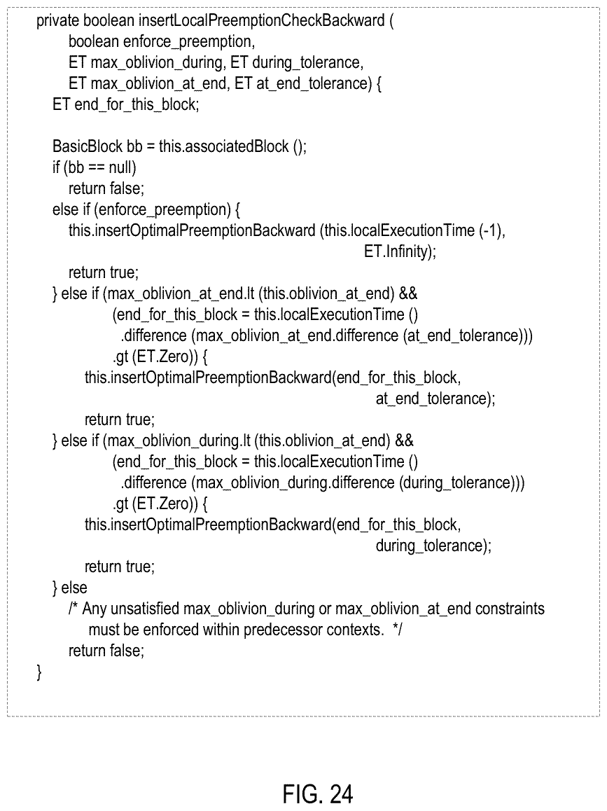

private boolean insertLocalPreemptionCheckBackward (boolean enforce_preemption, ET max_oblivion_during, ET during_tolerance, ET this.max_oblivion_at_end, ET at_end_tolerance): Insert one preemption check into the directly associated BasicBlock or into some predecessor of this BasicBlock if necessary in order to enforce the constraints specified by the arguments. The tolerance arguments specify the range within which the preemption checks should be inserted. Return true if a preemption check is inserted as this may require certain attributes associated with the CodePath data structure to be recomputed before it can be determined whether additional preemption checks need to be inserted. Otherwise, return false. FIG. 24 shows exemplary pseudocode for implementing the insertLocalPreemptionCheckBackward function according to embodiments of the present invention.

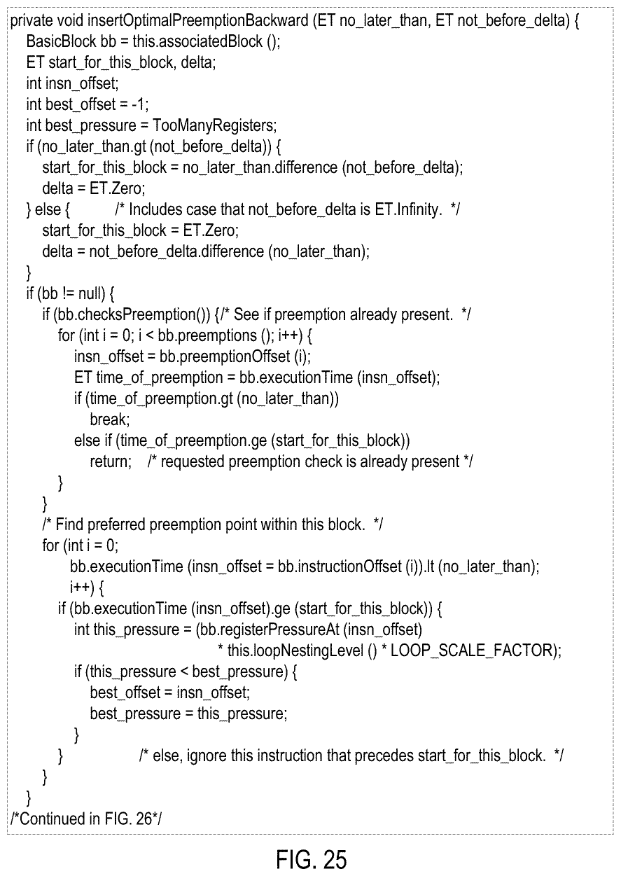

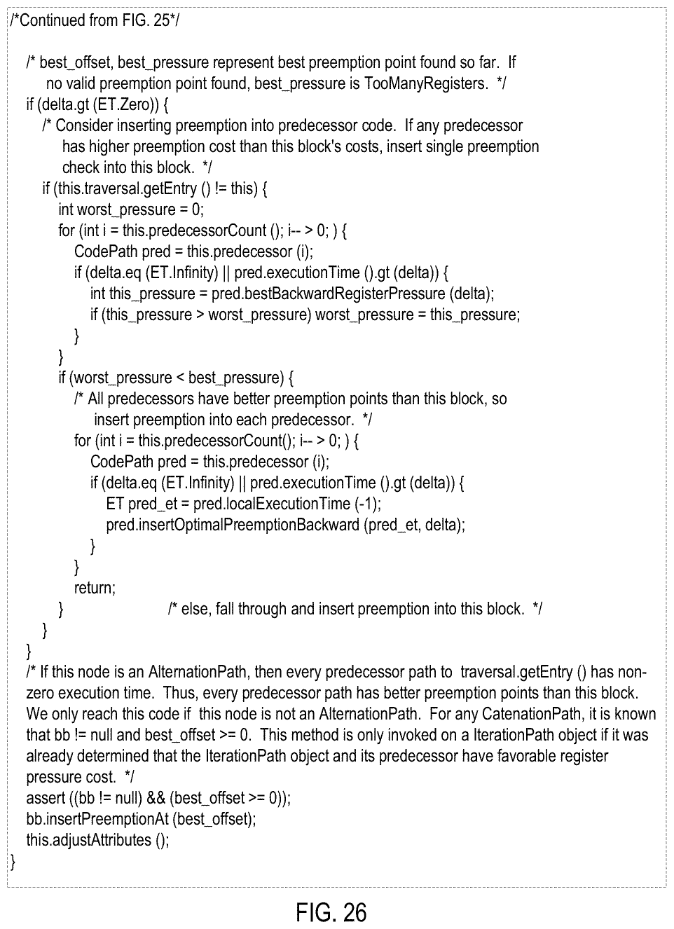

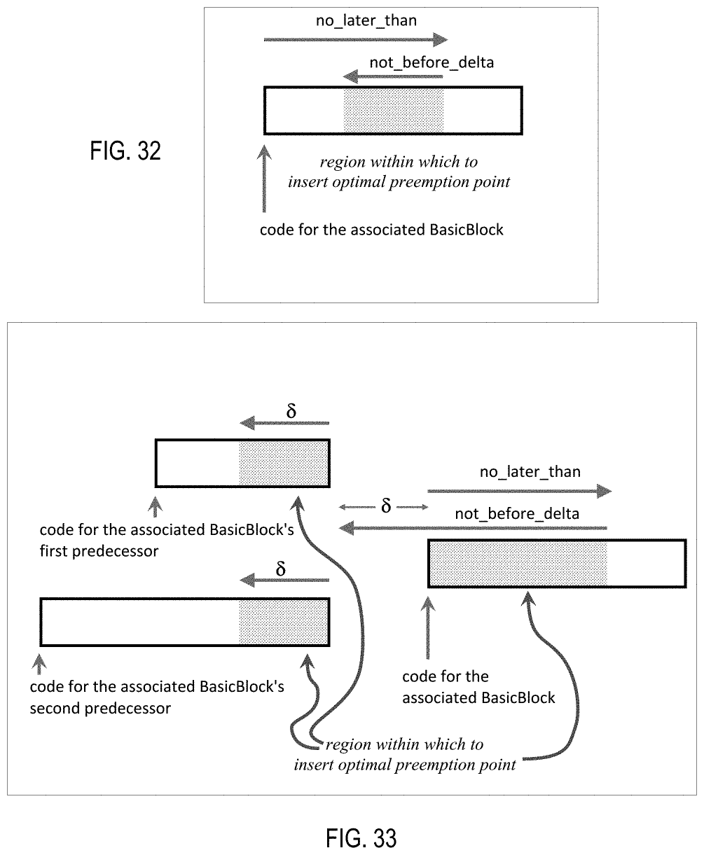

private void insertOptimalPreemptionBackward (ET no_later_than, ET not_before_delta): Insert a preemption point at an optimal control point before the first instruction within this CodePath object's associated BasicBlock that begins to execute following no_later_than execution time of the start of the basic block and after the last instruction that begins to execute at time not_before_delta prior to the no_later_than time. If not_before_delta equals ET.infinity, this method places preemption checks at “optimal” locations to assure that every control flow from this CodePath object to the associated traversal's end sentinel has a preemption check. The range of allowed preemption points is illustrated in FIGS. 32 and 33. In FIG. 32, not_before_delta is less than no_later_than, so the allowed region for insertion of preemption points is contained entirely within the associated BasicBlock. In FIG. 33, not_before_delta is greater than no_later_than by delta, so the allowed region for insertion of preemption points includes both the associated BasicBlock and its predecessors. Assume that a third predecessor of the associated BasicBlock, not shown in FIG. 33, has execution time that is shorter than delta. Suppose this predecessor equals this.traversal.getEntry ( ). Thus, the longest control flow prefix through this third predecessor is less than delta. Since insertOptimalPreemptionBackward has the role of enforcing max_oblivion_at_end and max_oblivion_during constraints, any prefix control flow that has less execution time than delta does not require insertion of preemption checks. Since the execution is less than delta, the oblivion associated with that path is also less than delta. In the case that this method decides to place the preemption point into a predecessor block, it inserts preemption points into each of the predecessors. The determination of which preemption point(s) within the region is (are) optimal is based on liveness of registers. Given multiple potential preemption points at the same loop nesting level, the best offset at which to preempt control is the offset at which registerPressureAt ( ) is minimal. If two candidate preemption points reside at different loop nesting levels, the preemption point that resides in a more deeply nested loop is considered less desirable by a factor of LOOP_SCALE_FACTOR. This symbolic constant typically holds a value of 10. FIGS. 25 and 26 show exemplary pseudocode for implementing the insertOptimalPreemptionBackward function according to embodiments of the present invention.

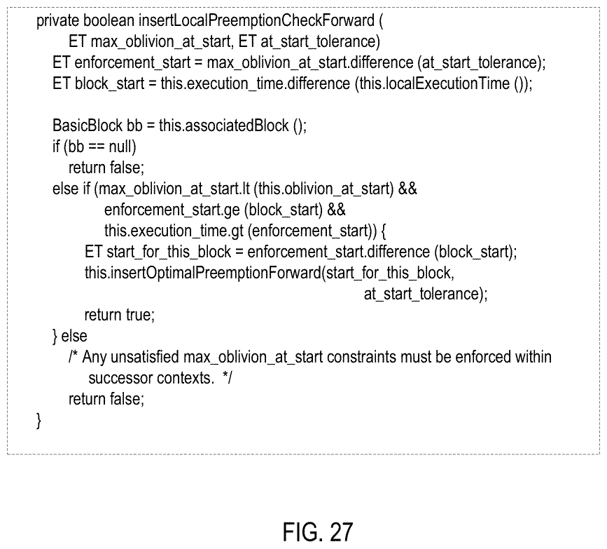

private boolean insertLocalPreemptionCheckForward (ET max_oblivion_at_start, ET at_start_tolerance): Insert one preemption check into the directly associated BasicBlock or into some successor of this BasicBlock if necessary in order to enforce the constraints specified by the arguments. The start_tolerance argument specifies the range within which the preemption check should be inserted. Return true if a preemption check is inserted as this may require certain attributes associated with the CodePath data structure to be recomputed before it can be determined whether additional preemption checks need to be inserted. Otherwise, return false. FIG. 27 shows exemplary pseudocode for implementing the insertLocalPreemptionCheckForward function according to embodiments of the present invention.

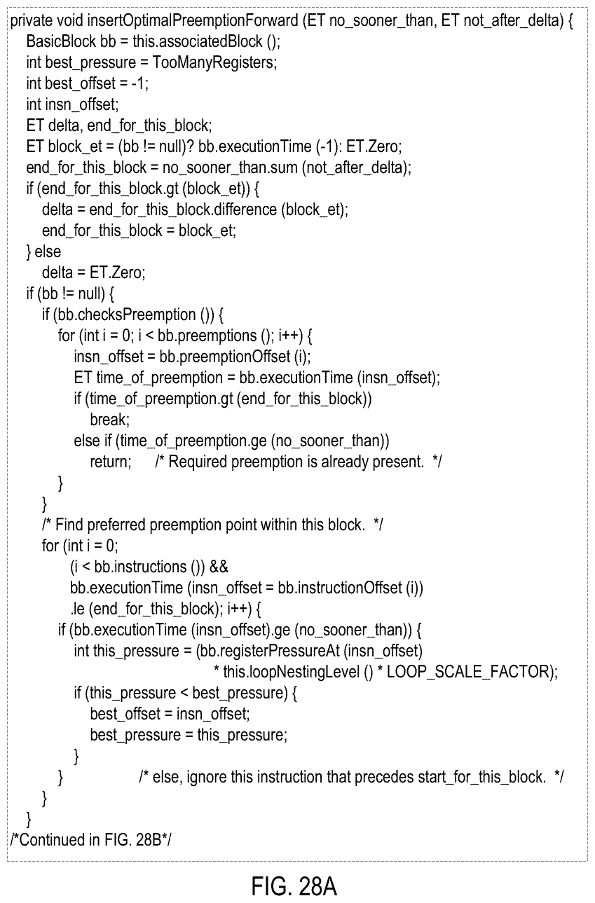

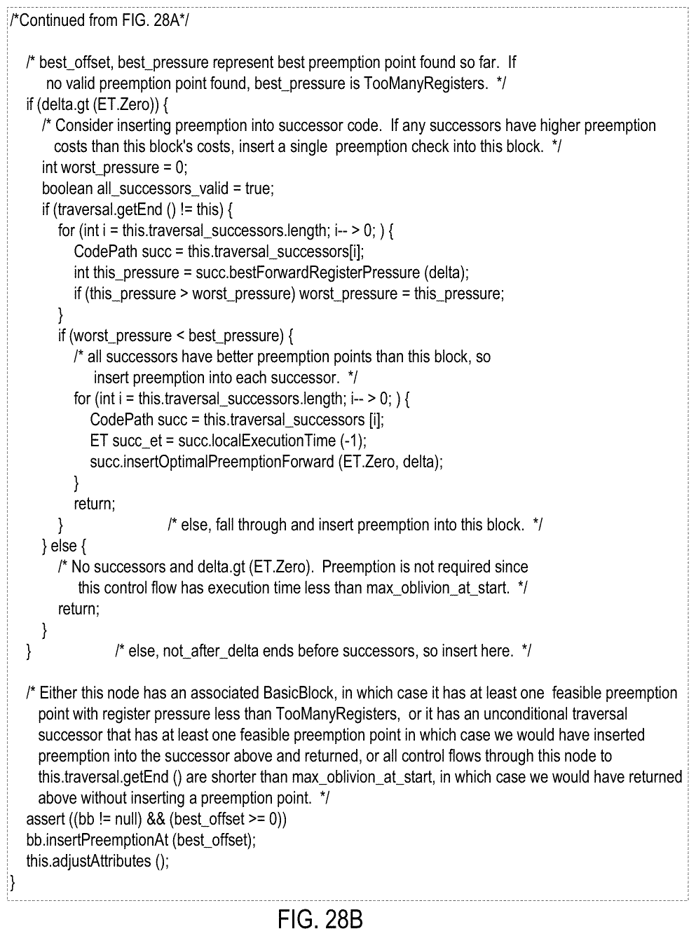

private void insertOptimalPreemptionForward (ET no_sooner_than, ET not_after_delta): Insert a preemption point at an optimal control point after the first instruction within this CodePath object's associated BasicBlock that begins to execute following no_sooner_than execution time of the start of the basic block and before the last instruction that begins to execute at time not_before_delta following the no_sooner_than time. In the case that this method decides to place the preemption point into a successor block, it inserts preemption points into each of the successors that requires it. The determination of which preemption point(s) within the region is (are) optimal is based on liveness of registers. Given multiple potential preemption points at the same loop nesting level, the best offset at which to preempt control is the offset at which registerPressureAt ( ) is minimal. If two candidate preemption points reside at different loop nesting levels, the preemption point that resides in a more deeply nested loop is considered less desirable by a factor of LOOP_SCALE_FACTOR. This symbolic constant typically holds a value of 10. Since insertOptimalPreemptionForward has the role of enforcing max_oblivion_at_start constraints, any suffix control flow that has less execution time than delta does not require insertion of preemption checks. When the suffix execution time is less than delta, the oblivion associated with the suffix path is also less than delta. FIGS. 28A and 28B show exemplary pseudocode for implementing the insertOptimalPreemptionForward function according to embodiments of the present invention.

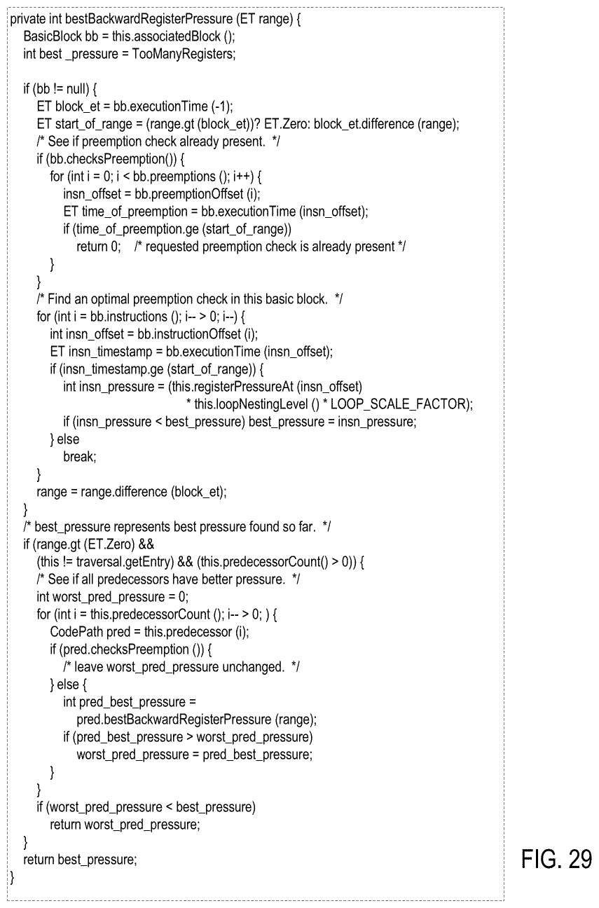

private int bestBackwardRegisterPressure (ET range): Determine the best register pressure available prior to the end of the code directly associated with this CodePath object, and within the specified range. The range may span code that belongs to predecessor CodePath objects. If range equals ET.Infinity, determine the best pointer register pressure available in the backwards traversal that ends with this.traversal ( ).getEntry ( ). If there are no instructions within range, return the symbolic constant TooManyRegisters, an integer value known to be larger than the number of registers supported by the target architecture. If a preemption check is already present within range, return a cost of zero to indicate that there is no incremental cost associated with using the preemption check that is already present. FIG. 29 shows exemplary pseudocode for implementing the bestBackwardRegisterPressure function according to embodiments of the present invention.

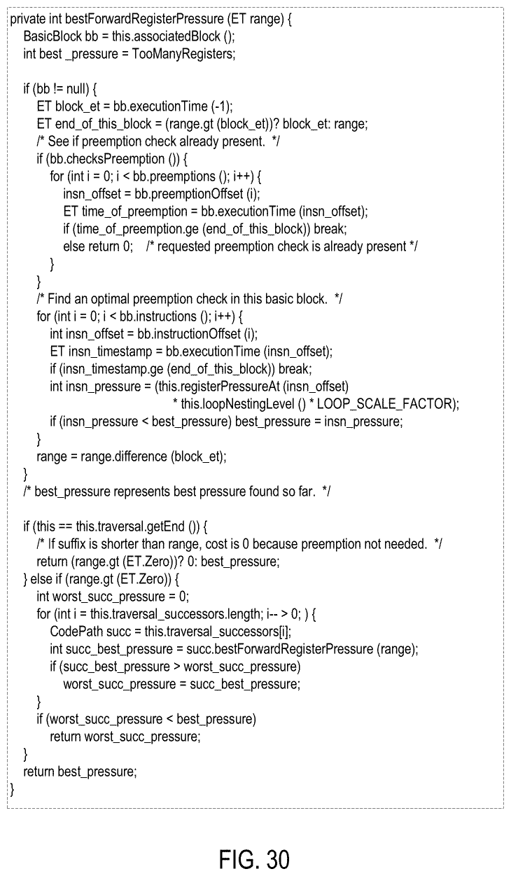

private int bestForwardRegisterPressure (ET range): Determine the best register pressure available following the start of the code directly associated with this CodePath object, and within the specified range. The range may span code that belongs to successor CodePath objects. If the range is longer than the execution time of this CodePath object and the longest transitive closure of its traversal successors, return 0. This indicates that there is no cost associated with insertion of preemption checks into this suffix control flow because a control flow with shorter execution time than the intended max_oblivion_at_start constraint does not require a preemption check. If a preemption check is already present, return a cost of zero to indicate that there is no incremental cost associated with using the preemption check that is already present. If there are no instructions within range, return the symbolic constant TooManyRegisters, an integer value known to be larger than the number of registers supported by the target architecture FIG. 30 shows exemplary pseudocode for implementing the bestForwardRegisterPressure function according to embodiments of the present invention.

Class AlternationPath:

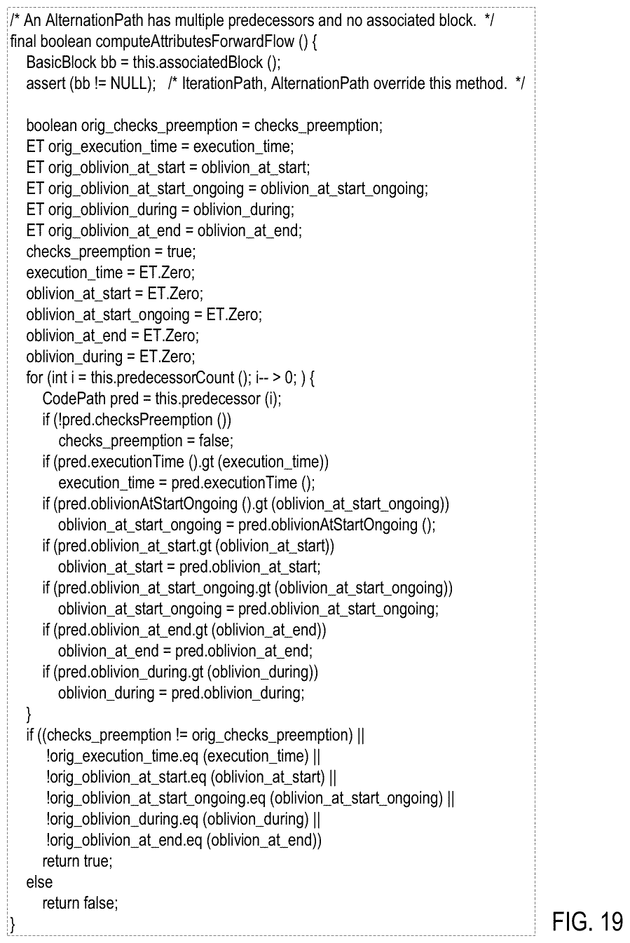

In an example embodiment according to the present disclosure, the class AlternationPath is a concrete subclass of CodePath. An AlternationPath represents the convergence of one or more control flows following a divergence of control flows that results from conditional branching. The subclass AlternationPath includes overriding implementations of the following methods of CodePath: initializeAttributesForwardFlow and computeAttributesForwardFlow. FIG. 16 shows exemplary pseudocode for implementing the initializeAttributesForwardFlow method of AlternationPath. FIG. 19 shows exemplary pseudocode for implementing the computeAttributesForwardFlow method of AlternationPath. Additional services supported by AlternationPath are:
AlternationPath (int num_alternatives): Instantiate an AlternationPath object that represents the convergence of num_alternatives control flows.
void establishAlternative (int n, CodePath alternative_flow): Establish alternative_flow as the nth alternative flow to be associated with this AlternationFlow object.
void setPredecessor (CodePath pred): Throws IllegalOperationException. An AlternationPath object does not have a predecessor in the traditional sense. Instead, it has a set of alternatives.

Class CatenationPath:

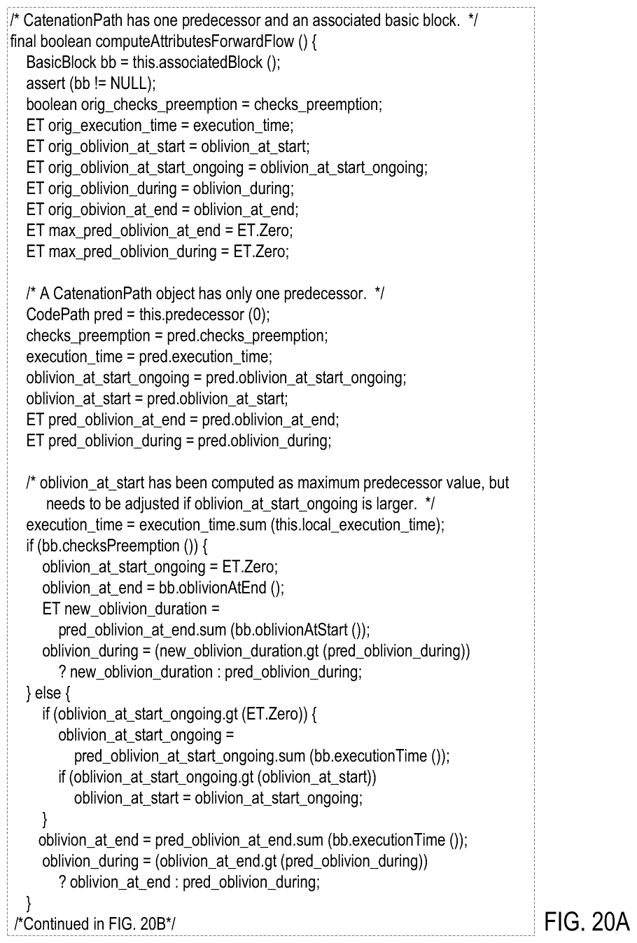

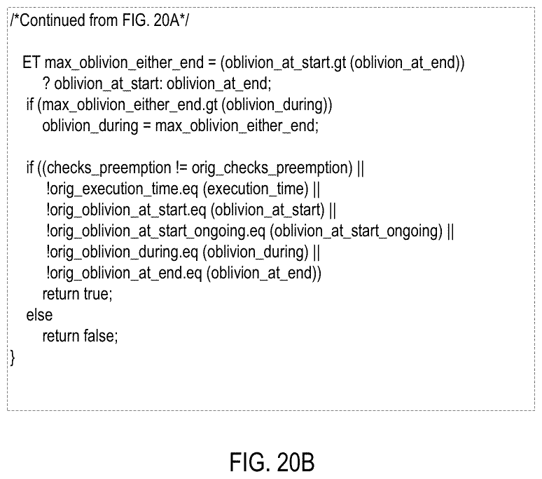

In an example embodiment according to the present disclosure, the class CatenationPath is a concrete subclass of CodePath. A CatenationPath is associated with a single BasicBlock object. The subclass CatenationPath includes overriding implementations of the following methods of CodePath: initializeAttributesForwardFlow and computeAttributesForwardFlow. FIG. 17 shows exemplary pseudocode for implementing the initializeAttributesForwardFlow method of CatenationPath. FIGS. 20A and 20B show exemplary pseudocode for implementing the computeAttributesForwardFlow method of CatenationPath. The service CatenationPath (BasicBlock associated block) instantiates a CatenationPath object to represent the associated BasicBlock object.

Class IterationPath:

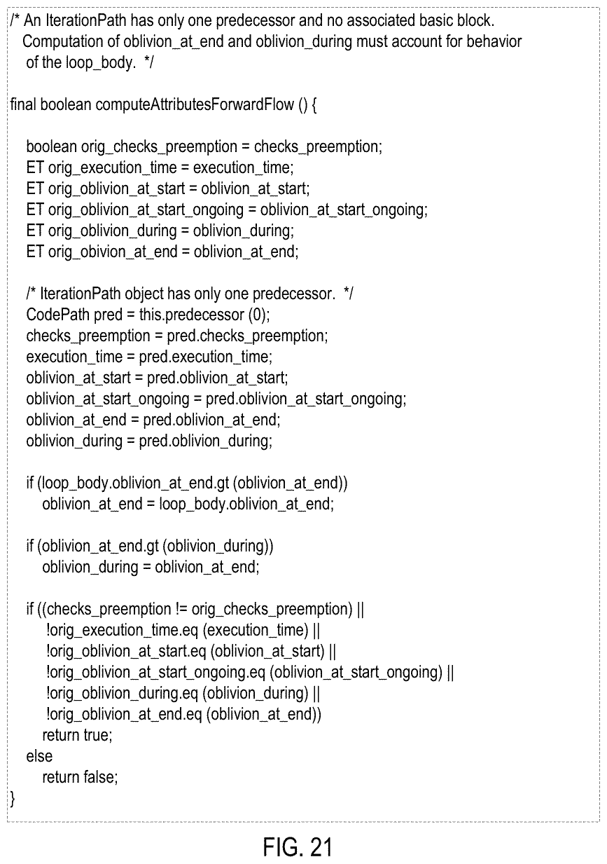

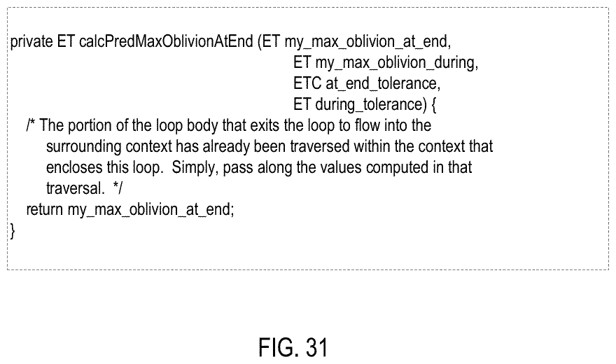

In an example embodiment according to the present disclosure, the class IterationPath is a concrete subclass of CodePath. An IterationPath represents the body of a loop. The subclass IterationPath includes overriding implementations of the following methods of CodePath: initializeAttributesForwardFlow, computeAttributesForwardFlow, and calcPredMaxOblivionAtEnd. FIG. 18 shows exemplary pseudocode of the initializeAttributesForwardFlow method of IterationPath according to embodiments of the present invention. FIG. 21 shows exemplary pseudocode of the computeAttributesForwardFlow method of IterationPath according to embodiments of the present invention. FIG. 31 shows exemplary pseudocode of the calcPredMaxOblivionAtEnd method of the IterationPath according to embodiments of the present invention. Additional services supported by this class are:
IterationPath (CodePath loop_body): Instantiate an IterationPath object to represent a loop with the specified loop_body. Following instantiation of this object, user code arranges for the entry node of the CodePath data structure that is referenced from loop_body to see this newly instantiated IterationPath as its predecessor.
CodePath loopBody ( ): Return a reference to the loop body associated with this IterationPath object.

Class Traversal:

In an example embodiment according to the present disclosure, the class Traversal is a class that represents the ability to traverse parts of a CodePath data structure. A Traversal instance maintains the following final instance fields:
final CodePath end: Refers to the constructor argument by the same name.
final CodePath start_sentinel: Refers to the constructor argument by the same name.
final CodePath entry: Computed during construction. This is the entry point for the Traversal. The single predecessor of entry equals start_sentinel.

In an example embodiment according to the present disclosure, services provided by the Traversal data type include:

Traversal (CodePath start_sentinel, CodePath end): Construct a Traversal object for the purpose of visiting all of the control flows from, but not including start_sentinel through the end node. The typical use of traversals is to analyze and transform control flows that are produced by reduction of a CFG. In the case that the intent of the traversal is to analyze a loop body (as identified by a T1 transformation), the start_sentinel value is the IterationPath node that represents the loop. In other cases (reductions by T2 transformations), the start_sentinel value is typically null. When a CodePath data structure is produced by a sequence of T1 and T2 transformations, the predecessor relationships form a directed acyclic graph (DAG) that is rooted at one or more end points. The cyclic data structure that represents a loop is formed through the use of a special loop_body field contained within the IterationPath node. For each end point associated with a particular reduction, the transitive closure of predecessor relationships eventually reaches the single CodePath node that is the entry point to the associated reduction. If every backward flowing path from end does not reach start_sentinel, the arguments to the Traversal instantiation are considered invalid. An instantiated Traversal object can be used to perform traversals of this DAG only until another Traversal object spanning one or more of the same CodePath objects as this Traversal object is instantiated. The Traversal constructor performs the following:

this.end = end;
this.start_sentinel = start_sentinel;
end.accommodateTraversalPassOne (start_sentinel);
this.entry = end.accommodateTraversalPassTwo (this);

public getEntry ( ): This method returns a reference to the CodePath object that represents the entry node for this traversal.

public getEnd ( ): This method returns a reference to the CodePath object that represents the end node for this traversal.

public computeAttributes ( ): This method has the effect of computing the attributes for each CodePath node along all control flows from start_sentinel, exclusive, to end, and may be implemented by this.entry.computeAttributes ( ).

public void insertPreemptionPoints (boolean enforce_preemption, ET max_oblivion_at_start, ET at_start_tolerance, ET max_oblivion_during, ET during_tolerance, ET max_oblivion_at_end, ET at_end_tolerance): This method inserts any preemption checks that are required to enforce that every control flow rho between the start_sentinel CodePath object, exclusive, and the end CodePath object, inclusive, honor the constraints that rho.oblivionAtStart ( )≤max_oblivion_at_start, rho.oblivionDuring ( )≤max_oblivion_during, rho.oblivionAtEnd ( )≤max_oblivion_at_end. Furthermore, if enforce_preemption is true, this method assures that every such control flow rho has a preemption check. The computeAttributes method must be invoked before the insertPreemptionChecks method. A Traversal object's insertPreemptionChecks method performs the following to begin the process of inserting preemption points into the control flows represented by the Traversal object:

if (end.oblivionAtStart ( ).le (max_oblivion_at_start))

max_oblivion_at_start = ET.Infinity;

if (end.oblivionAtEnd ( ).le (max_oblivion_at_end))

max_oblivion_at_end = ET. Infinity;

if (end.oblivionDuring ( ).le (max_oblivion_during))

max_oblivion_during = ET. Infinity;

if (end.checksPreemption ( ))

enforce_preemption= false;

end.insertPreemptionChecks (enforce_preemption,

max_oblivion_at_start, at_start_tolerance,
max_oblivion_during, during_tolerance,
max_oblivion_at_end, at_end_tolerance).

Class Reduction:

In an example embodiment according to the present disclosure, the class Reduction is a concrete class that represents a region of a method's reducible control-flow graph (CFG). The instance fields implemented by this type are:
CodePath entry: The CodePath object through which all control flows to enter into the region represented by this Reduction object.
CodePath terminating path: If non-null, this Reduction object spans the terminating CodePath object, which is referenced from this field. The terminatingCodePath object is the last CodePath object in the method. If a method contains multiple return statements, the successor of each block ending with a return statement is the terminating CodePath object.
Reduction [ ] inward_flows: This array holds all of the Reduction objects that represent regions of code from which control can flow into this Reduction object's region of code. If this Reduction has an inward flow from itself, the self-referential flow is included in the inward_flows array.
Reduction [ ] outward_flows: This array holds all of the Reduction objects that represent regions of code to which control can flow from this Reduction object's region of code. If this Reduction has an outward flow back to itself, the self-referential flow is included in the outward_flows array.
CodePath [ ] [ ] outward_paths: For each of the regions of code to which control may flow from this Reduction object, the inner-nested array represents all of the CodePath objects residing within this region of code through which control may flow directly to a CodePath object residing in the associated Reduction object's region of code.

In accordance with embodiments of the present disclosure, various services implemented by the Reduction type are described below:

Reduction (CatenationPath associated_path): Construct a Reduction object to represent associated_path. This form of the constructor is used to build a Reduction-based representation of a method's CFG. It is assumed that the associated_path object has no predecessors. Space is reserved within the constructed Reduction object to represent the number of outward flows indicated by associated_path.associatedBlock ( ).predecessorCount ( ). The implementation comprises:

this.entry = assocated_path;
this.terminating_path = null;
int successors = associated_path.associatedBlock ( ).numSuccessors ( );
this.outward_flows = new Reduction [successors]
this.outward_paths = new CodePath [successors][ ];
int predecessors = associated_path.numPredecessors ( );
this.inward_flows = new Reduction [predecessors];

Reduction (CatenationPath associated_path, boolean is terminating): Construct a Reduction object to represent associated_path. If is terminating is true, mark this Reduction object as a terminating Reduction and identify the associated_path as a terminating path. The implementation comprises:

super (associated_path);
if (is_terminating)
this.terminating_path = associated_path;

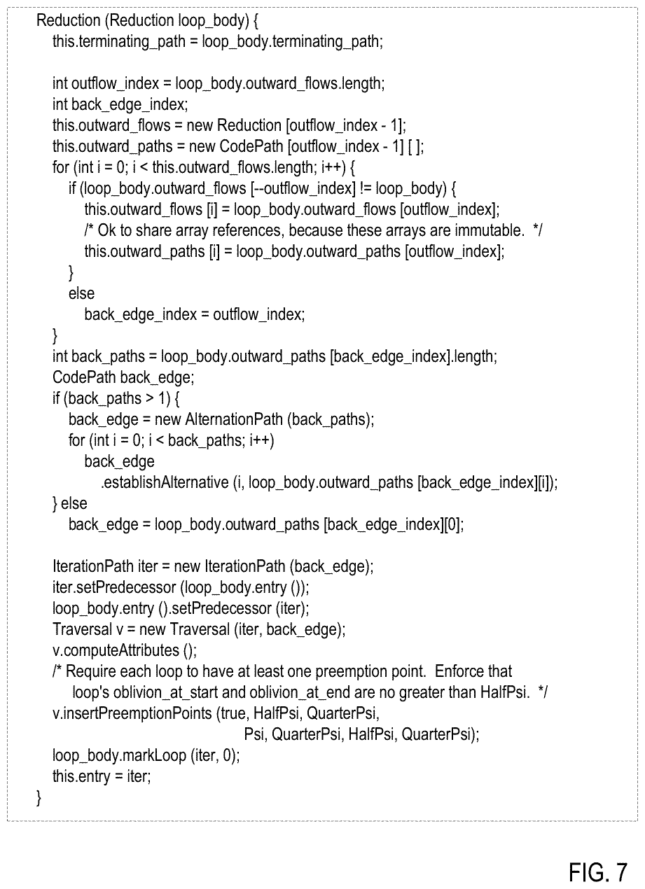

Reduction (Reduction loop_body): Construct a Reduction object to represent a loop whose body is represented by the previously constructed Reduction supplied as an argument. This form of the constructor is used in the implementation of a T1 transformation. A side effect of this constructor is to instantiate a new IterationPath object iteration_path and enforce that the loop body has appropriate preemption checks. Additionally, each CodePath node that is contained within traversal (iteration_path.loop_body, iteration_path) has its loop nesting level incremented by 1. The outward flows for the newly constructed Reduction are the same outward flows as for loop_body except for the self-referential outward flow that is eliminated by this T1 transformation. FIG. 7 shows exemplary pseudocode for implementing the Reduction (Reduction loop_body) function according to embodiments of the present invention.

Reduction (Reduction pred_region, Reduction succ_region): Construct a Reduction object to represent the catenation of pred_region and succ_region. This form of the constructor is used in the implementation of a T2 transformation. The outward flows for the newly constructed Reduction are the same as the union of outward flows for pred_region and succ_region, with removal of the outward flow from pred_region to succ_region unless succ_region has a self-referential outward flow. If succ_region has a self-referential outward flow, the newly constructed Reduction object will also have a self-referential outward flow. FIGS. 8A and 8B show exemplary pseudocode for implementing the Reduction (Reduction pred_region, Reduction succ_region) function according to embodiments of the present invention.

void establishOutwardFlow (int n, Reduction r): set the destination of the n^{th} outward flow from this Reduction object to be r. The first outward flow is identified by n=0. This method is typically only used for Reduction objects that are constructed using the forms that expect a CatenationPath argument. At the time the Reduction is instantiated, space is reserved to represent as many outward flows as the supplied associatedpath.associatedBlock ( ) has successors. The outward flows are established as each of the successor basic blocks becomes associated with a corresponding Reduction object.

void establishInwardFlow (int n, Reduction r): set the source of the n^{th} inward flow into this Reduction object to be r. The first inward flow is identified by n=0. This method is typically only used for Reduction objects that are constructed using the forms that expect a CatenationPath argument. At the time the Reduction is instantiated, space is reserved to represent as many inward flows as the supplied associated_path.associatedBlock ( ) has predecessors. The inward flows are established as each of the predecessor basic blocks becomes associated with a corresponding Reduction object.

final CodePath entry ( ): Given that the CFG is assumed to be reducible and that each Reduction represents either a single CatenationPath node or is the result of a T1 or T2 transformation, each Reduction has a single entry point. This method returns a reference to that entry point.

final CodePath terminatingPath ( ): If this Reduction spans the terminating node, return a reference to the node. Otherwise, return null.

int inwardFlows ( ): Queries how many inward flows enter this Reduction. An inward flow is a control flow originating in a region of code associated with some other Reduction object, or possibly even associated with this same Reduction object and flowing into the region of code represented by this Reduction object. Each Reduction object maintains a representation of all of its inward flows.

Reduction inwardFlow (int n): Queries from which source Reduction does control flow for the n^{th} inward flow to this Reduction. The first inward flow is identified as n=0.

int outwardFlows ( ): Queries how many outward flows depart this Reduction. An outward flow is a control flow from the region of code represented by this Reduction to the region of code represented by some other Reduction or possibly by this same Reduction. Each Reduction object maintains a representation of all of its outward flows. For each outward flow, the Reduction also keeps track of all the CodePath objects that map to the outward flow.

Reduction outwardFlow (int n): Queries to which destination Reduction does control flow for the n^{th} outward flow from this Reduction. The first outward flow is identified as n=0.

private int outwardPaths (int n): Queries how many outgoing CodePath objects are associated with the n^{th} outward flow from this Reduction. Since the associated CFG is assumed to be reducible, each of the associated CodePath objects must flow to the same CodePath object, which is the entry block for the region represented by outwardFlow (n).

private CodePath outwardPath (int n, int p): Return the CodePath object to which the p^{th} CodePath object associated with the n^{th} control flow departing this Reduction flows.

In an example embodiment according to the present disclosure, the insertion of preemption checks into a method body is the last step of compilation, after all optimization phases have been completed and all code has been generated. Insert a preemption check into the prologue method within alpha execution time from method entry. In the typical scenario, this preemption check occurs immediately after all callee-saved registers have been saved into the new method's activation frame. Assume the CFG already exists and assume the CFG is reducible. Perform node splitting as necessary in order to make the CFG reducible if it is not already reducible. For any BasicBlock object that ends with return from the function, mark this BasicBlock as having a preemption check after its last instruction. If the CFG has multiple basic blocks that return from the function, create a single new BasicBlock object to represent the function's end point and insert this BasicBlock object into the CFG with all of the originally returning BasicBlock objects as its predecessors. Call this new basic block the terminating basic block. Call the CatenationPath node that is associated with this basic block the terminating path. Call the associated Reduction object a terminating Reduction. If there is only one basic block that returns from the function, identify the CatenationPath node associated with that basic block as the terminating path, identifying the associated Reduction object as the terminating Reduction. Allocate an array active_reductions of Reduction object references with as many array elements as there exist BasicBlock objects in the existing CFG. Walk the CFG, instantiating a CatenationPath object to represent each existing BasicBlock and a Reduction object to represent each CatenationPath. Establish the outward flows and inward flows for each instantiated Reduction object. Insert a reference to each newly instantiated Reduction object into the active_reductions array. Set the variable num_active_reductions to represent the size of the active_reductions array. Resolve active Reduction objects, for example, by executing the loop in Table 1. At this point, there is only active Reduction. Assure that it satisfies the preemption constraints, for example, using the implementation in Table 2, where Psi is the preemption latency parameter.

TABLE 1
while (num_active_reductions > 1) {

for (int i = 0; i < num_active_reductions; i++) {

Reduction = active_reductions [i];
if ((reduction.inwardFlows ( ) == 1)

&& (reduction.inwardFlow (0) != reduction)) {
/* Do a T2 transformation. */
Reduction predecessor = reduction.inwardFlow (0);
Reduction r = new Reduction (predecessor, reduction);
/* Replace the successor with r. */
active_reductions [i] = r;
/* Remove the predecessor. */
for (int j = 0; active_reductions [j] != predecessor; j++);
/* j is index of predecessor. */
while (++j < num_active_reductions)

active_reductions [j−1] = active_reductions [j];

num_active_reductions−−;

| | |
|---|---|
| break; | /* Restart the outer loop. */ |

} else if (reduction.outwardFlows ( ) > 0) {

boolean found_T1 = false;
for (int j = reduction.outwardFlows ( ); j−− > 0; ) {

Reduction loop_candidate = reduction.outwardFlow (j);
if (loop_candidate == reduction) {

found_T1 = true;
break;

}

| } | |
|---|---|
| if (found_T1) { | /* Do a T1 transformation. */ |

| active_reductions [i] = new Reduction (loop_candidate); | |
|---|---|
| break; | /* Restart the outer loop. */ |

} /* else, continue search for an eligible T1 or T2 transformation. */

} /* likewise, continue search for an eligible T1 or T2 transformation. */

}

TABLE 2

CodePath end = active_reductions [0].terminatingPath ( );
Traversal t = new Traversal (null, end);
t.computeAttributes ( );
t.insertPreemptionPoints (false,

ET.Infinity, ET.Zero, Psi, QuarterPsi, ET.Infinity, ET.Zero)

In view of the explanations set forth above, the placement of explicit preemption points into compiled code according to embodiments of the present disclosure serves the needs of soft real-time developers as well as hard real-time developers. Whereas developers of hard real-time systems are generally expected to budget for the worst-case behavior of every software component, soft real-time developers are generally more interested in expected behavior. A hard real-time system is expected to never miss any deadline. In contrast, a soft real-time engineer is expected to effectively manage deadlines. Managing deadlines comprises endeavoring to reduce the likelihood of misses, providing appropriate handling when deadlines are occasionally missed, and assuring system stability in the face of transient work overloads. There are many reasons that soft real-time is harder than hard real-time. For example, soft real-time systems tend to be larger and much more complex. The soft real-time workload tends to be much less predictable. The very severe constraints of hard real-time systems are only relevant to very simple algorithms with very predictable workloads.

Whereas a hard real-time system is either correct (always satisfying all timing constraints), or incorrect (failing to satisfy some timing constraints some of the time), most soft real-time systems are held to more nuanced standards of quality. For example, soft real-time systems may address the need to: minimize the number of deadlines missed, minimize the total amount of lateness, adjust priorities to miss only the “less important” deadlines while honoring more important deadlines, dynamically adjust service quality to maximize the utility of work that can be reliably completed with available resources, and/or design for stability in the face of transient work overloads, assuring that the most important time-critical work is still performed reliably even when certain resources must be temporarily reassigned to the task of determining how to effectively deal with oversubscription of system capacity.

Exemplary embodiments of the present disclosure are described largely in the context of a fully functional computer system for placement of explicit preemption points into compiled code. Readers of skill in the art will recognize, however, that the present disclosure also may be embodied in a computer program product disposed upon computer readable storage media for use with any suitable data processing system. Such computer readable storage media may be any storage medium for machine-readable information, including magnetic media, optical media, or other suitable media. Examples of such media include magnetic disks in hard drives or diskettes, compact disks for optical drives, magnetic tape, and others as will occur to those of skill in the art. Persons skilled in the art will immediately recognize that any computer system having suitable programming means will be capable of executing the steps of the method of the invention as embodied in a computer program product. Persons skilled in the art will recognize also that, although some of the exemplary embodiments described in this specification are oriented to software installed and executing on computer hardware, nevertheless, alternative embodiments implemented as firmware or as hardware are well within the scope of the present disclosure.

The present disclosure may be a system, a method, and/or a computer program product. The computer program product may include a computer readable storage medium (or media) having computer readable program instructions thereon for causing a processor to carry out aspects of the present disclosure.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present disclosure may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present disclosure.

Aspects of the present disclosure are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present disclosure. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

It will be understood from the foregoing description that modifications and changes may be made in various embodiments of the present disclosure without departing from its true spirit. The descriptions in this specification are for purposes of illustration only and are not to be construed in a limiting sense. The scope of the present disclosure is limited only by the language of the following claims.

1. A method for the placement of explicit preemption points into compiled code, comprising:
creating, from executable code, a control flow graph that includes every control path in a function;
determining, from the control flow graph, an estimated execution time for each control path;
determining, for each control path, whether an estimated execution time of a control path exceeds a preemption latency parameter, wherein the preemption latency parameter is a maximum allowable time between preemption points, and wherein the estimated execution time is based on expected-case instruction timings for instructions along each control path;
determining that the estimated execution time of a particular control path violates the preemption latency parameter; and
placing an explicit preemption point into the executable code that satisfies the preemption latency parameter.

2. The method of claim 1 wherein determining, from the control flow graph, an estimated execution time for each control path includes determining an estimated execution time for each basic block in the function.

3. The method of claim 1 wherein the compiled code executes within a managed run-time environment.

4. The method of claim 1 wherein placing an explicit preemption point into the executable code that satisfies the preemption latency parameter includes applying optimizing criteria that reduces the cost of performing context switches at each preemption point.

5. The method of claim 4 wherein the optimizing criteria includes at least one of a minimized number of live pointer variables and a minimized number of all live registers.

6. The method of claim 1, wherein the estimated execution time based on expected-case instruction timings for every instruction along every control path includes multiplying a number of instructions by an average number of cycles per instruction.

7. The method of claim 1 wherein the estimated execution time is based on worst-case instruction timings for every instruction along every control path.

8. An apparatus for placement of explicit preemption points into compiled code, the apparatus comprising a computer processor, a computer memory operatively coupled to the computer processor, the computer memory having disposed within it computer program instructions that, when executed by the computer processor, cause the apparatus to carry out the steps of:
creating, from executable code, a control flow graph that includes every control path in a function;
determining, from the control flow graph, an estimated execution time for each control path;
determining, for each control path, whether an estimated execution time of a control path exceeds a preemption latency parameter, wherein the preemption latency parameter is a maximum allowable time between preemption points, and wherein the estimated execution time is based on expected-case instruction timings for instructions along each control path;
determining that the estimated execution time of a particular control path violates the preemption latency parameter; and
placing an explicit preemption point into the executable code that satisfies the preemption latency parameter.

9. The apparatus of claim 8 wherein determining, from the control flow graph, an estimated execution time for each control path includes determining an estimated execution time for each basic block in the function.

10. The apparatus of claim 8 wherein the compiled code executes within a managed run-time environment.

11. The apparatus of claim 8 wherein placing an explicit preemption point into the executable code that satisfies the preemption latency parameter includes applying optimizing criteria that reduces the cost of performing context switches at each preemption point.

12. The apparatus of claim 11 wherein the optimizing criteria includes at least one of a minimized number of live pointer variables and a minimized number of all live registers.

13. The apparatus of claim 8, wherein the estimated execution time based on expected-case instruction timings for every instruction along every control path includes multiplying a number of instructions by an average number of cycles per instruction.

14. The apparatus of claim 8 wherein the estimated execution time is based on worst-case instruction timings for every instruction along every control path.

15. A computer program product for placement of explicit preemption points into compiled code, the computer program product comprising a non-transitory computer readable medium having computer program instructions embodied therewith that, when executed, cause a computer to carry out the steps of:
creating, from executable code, a control flow graph that includes every control path in a function;
determining, from the control flow graph, an estimated execution time for each control path;
determining, for each control path, whether an estimated execution time of a control path exceeds a preemption latency parameter, wherein the preemption latency parameter is a maximum allowable time between preemption points, and wherein the estimated execution time is based on expected-case instruction timings for instructions along each control path;
determining that the estimated execution time of a particular control path violates the preemption latency parameter; and
placing an explicit preemption point into the executable code that satisfies the preemption latency parameter.

16. The computer program product of claim 15 wherein determining, from the control flow graph, an estimated execution time for each control path includes determining an estimated execution time for each basic block in the function.

17. The computer program product of claim 15 wherein the compiled code executes within a managed run-time environment.

18. The computer program product of claim 15 wherein placing an explicit preemption point into the executable code that satisfies the preemption latency parameter includes applying optimizing criteria that reduces the cost of performing context switches at each preemption point.

19. The computer program product of claim 18 wherein the optimizing criteria includes at least one of a minimized number of live pointer variables and a minimized number of all live registers.

20. The computer program product of claim 15 wherein the estimated execution time based on expected-case instruction timings for every instruction along every control path includes multiplying a number of instructions by an average number of cycles per instruction.
